(19) United States
(12) Patent Application Publication
(10) Pub. No.: US 2025/0100284 A1
(43) Pub. Date: Mar. 27, 2025

(54) MAINTENANCE METHOD AND LIQUID DISCHARGE APPARATUS

(71) Applicant: SEIKO EPSON CORPORATION, Tokyo (JP)

(72) Inventors: Naoki TAKAHASHI, SHIOJIRI-SHI (JP); Kenichiro MATSUO, MATSUMOTO-SHI (JP)

(21) Appl. No.: 18/893,361

(22) Filed: Sep. 23, 2024

(30) Foreign Application Priority Data
Sep. 25, 2023 (JP) 2023-159975

(51) Int. Cl. B41J 2/165; B41J 2/195

(52) U.S. Cl. CPC B41J 2/1652; B41J 2/16579; B41J 2/195; B41J 2002/16573

(57) ABSTRACT

A maintenance method of a liquid discharge apparatus including a plurality of discharge sections: acquiring a first viscosity information on viscosity of the liquid filled in each of the plurality of discharge sections; causing each of the plurality of discharge sections to discharge a first amount of the liquid; acquiring a second viscosity information on viscosity of the liquid filled in each of the plurality of discharge sections; generating a difference information indicating a difference between the viscosity indicated by the first viscosity information and the viscosity indicated by the second viscosity information in each of the plurality of discharge sections; causing a discharge section in which the difference indicated by the difference information is equal to or greater than a predetermined value among the plurality of discharge sections, to discharge the first amount of the liquid again.

The present application is based on, and claims priority from JP Application Serial Number 2023-159975, filed Sep. 25, 2023, the disclosure of which is hereby incorporated by reference herein in its entirety.

### BACKGROUND

### 1. Technical Field

The present disclosure relates to a maintenance method and a liquid discharge apparatus.

### 2. Related Art

In a liquid discharge apparatus including a discharge section that discharges liquid from a nozzle, the nozzle may be clogged, and the liquid may not be discharged from the nozzle.

Therefore, in order to prevent such clogging of the nozzle, a flushing operation of discharging the liquid from the discharge section is executed. For example, JP-A-2000-233518 discloses a technique of determining in advance an amount of liquid to be discharged from a discharge section in a flushing operation and discharging the predetermined amount of liquid in the flushing operation.

In the technique according to JP-A-2000-233518, since the predetermined amount of liquid is discharged in the flushing operation, an amount of ink discharged in the flushing operation may exceed a discharge amount required to ensure a print quality in a liquid discharge apparatus.

### SUMMARY

According to an aspect of the present disclosure, there is provided a maintenance method for a liquid discharge apparatus including a plurality of discharge sections that discharge liquid, the maintenance method including: acquiring first viscosity information on viscosity of the liquid filled in each of the plurality of discharge sections; causing each of the plurality of discharge sections to discharge a first amount of the liquid; acquiring second viscosity information on viscosity of the liquid filled in each of the plurality of discharge sections; generating difference information indicating a difference between the viscosity indicated by the first viscosity information and the viscosity indicated by the second viscosity information in each of the plurality of discharge sections; causing a discharge section in which the difference indicated by the difference information is equal to or greater than a predetermined value among the plurality of discharge sections, to discharge the first amount of the liquid again; and causing a discharge section in which the difference indicated by the difference information is less than the predetermined value among the plurality of discharge sections, not to discharge the liquid.

According to an aspect of the present disclosure, there is provided a liquid discharge apparatus including: a plurality of discharge sections that discharge liquid; an acquisition section that acquires viscosity information on viscosity of the liquid filled in each of the plurality of discharge sections; a discharge control section that causes each of the plurality of discharge sections to discharge the liquid; and a generation section that, when the acquisition section acquires first viscosity information on viscosity of the liquid filled in each of the plurality of discharge sections, the discharge control section causes each of the plurality of discharge sections to discharge a first amount of the liquid, and then the acquisition section acquires second viscosity information on viscosity of the liquid filled in each of the plurality of discharge sections, generates difference information indicating a difference between the viscosity indicated by the first viscosity information and the viscosity indicated by the second viscosity information, in which the discharge control section causes a discharge section in which the difference indicated by the difference information is equal to or greater than a predetermined value among the plurality of discharge sections, to discharge the first amount of the liquid again, and causes a discharge section in which the difference indicated by the difference information is less than the predetermined value among the plurality of discharge sections, not to discharge the liquid.

### BRIEF DESCRIPTION OF THE DRAWINGS

FIG. 1 is a functional block diagram illustrating an example of a configuration of an ink jet printer.

FIG. 2 is a schematic view illustrating the ink jet printer.

FIG. 3 is a schematic partial cross-sectional view of a recording head.

FIG. 4 is a block diagram illustrating an example of a configuration of a head unit.

FIG. 5 is a timing chart illustrating an operation of the ink jet printer in a unit period.

FIG. 6 is an explanatory diagram illustrating generation of coupling state designation signals.

FIG. 7 is an explanatory diagram illustrating an example of a residual vibration signal.

FIG. 8 is an explanatory diagram illustrating an ink discharge process for one discharge section.

FIG. 9 is an explanatory diagram illustrating an ink discharge process for one discharge section.

FIG. 10 is a flowchart illustrating an operation of a control section.

FIG. 11 is a functional block diagram illustrating an example of a configuration of an ink jet printer.

FIG. 12 is an explanatory diagram illustrating an ink discharge process for one discharge section.

FIG. 13 is a schematic view of the discharge section.

FIG. 14 is a table illustrating the number of shots in an n-th flushing process.

FIG. 15 is a flowchart illustrating an operation of a control section.

FIG. 16 is a table illustrating the number of shots in the n-th flushing process.

FIG. 17 is a flowchart illustrating the operation of the control section.

FIG. 18 is a flowchart illustrating the operation of the control section.

### DESCRIPTION OF EMBODIMENTS

Hereinafter, embodiments for implementing the present disclosure will be described with reference to the drawings. However, in each of the drawings, a dimension and a scale of each section are appropriately different from the actual dimension and scale. Since the embodiments described below are preferred specific examples of the present disclosure, various technically preferable limitations are given, but the scope of the present disclosure is not limited to these embodiments unless otherwise specified in the following description to the effect that the present disclosure is limited thereto.

### 1: First Embodiment

In the present embodiment, a liquid discharge apparatus will be described with an ink jet printer 1 that discharges ink I to form an image on recording paper Pp as an example. The ink jet printer 1 is an example of a “liquid discharge apparatus”. The ink I is an example of “liquid”. The recording paper Pp is an example of a “medium”.

### 1-1: Overview of Ink Jet Printer 1

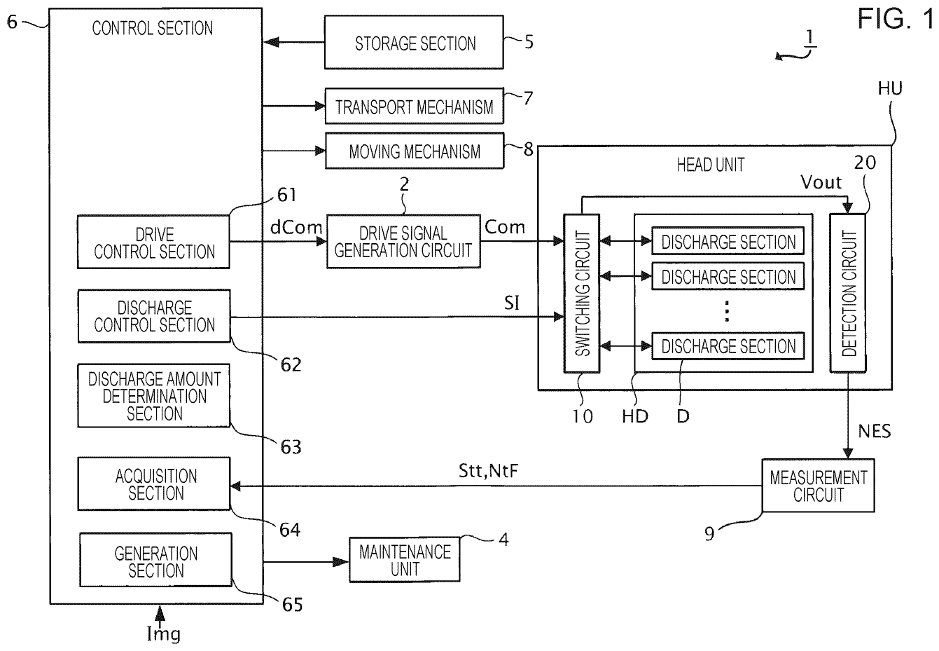

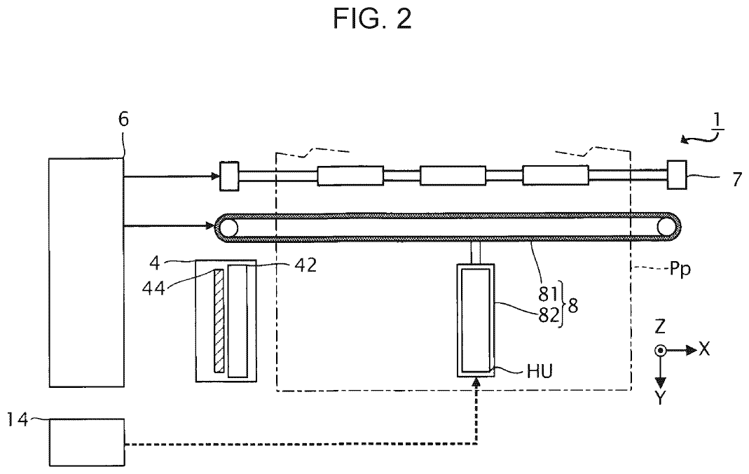

A configuration of the ink jet printer 1 according to the present embodiment will be described with reference to FIGS. 1 and 2. FIG. 1 is a functional block diagram illustrating an example of the configuration of the ink jet printer 1 according to the present embodiment. FIG. 2 is a schematic view illustrating the ink jet printer 1.

The ink jet printer 1 receives print data Img indicating an image to be formed by the ink jet printer 1 and information indicating the number of print copies of the image to be formed by the ink jet printer 1, which are supplied from a host computer such as a personal computer or a digital camera. The ink jet printer 1 executes a print process of forming the image indicated by the print data Img supplied from the host computer on the recording paper Pp.

As illustrated in FIG. 1, the ink jet printer 1 includes a head unit HU provided with a discharge section D that discharges the ink I, a control section 6 that controls an operation of each section of the ink jet printer 1, a drive signal generation circuit 2 that generates a drive signal Com for driving the discharge section D, a storage section 5 that stores a control program of the ink jet printer 1 and other information, a measurement circuit 9 that determines a discharge state of the discharge section D and outputs determination information Stt indicating a result of the discharge state and phase information NtF on viscosity of the ink I in the discharge section D, a transport mechanism 7 that transports the recording paper Pp, a moving mechanism 8 that moves the head unit HU, and a maintenance unit 4 that executes a maintenance process of performing maintenance of the discharge section D such that the ink I is normally discharged from the discharge section D.

In the present embodiment, the head unit HU includes a recording head HD provided with M discharge sections D, a switching circuit 10, and a detection circuit 20. In the present embodiment, M is an integer of 2 or more.

Hereinafter, in order to distinguish between the M discharge sections D provided in the recording head HD, the M discharge sections D may be referred to as a first stage, a second stage, . . . , an M stage in order. An m stage discharge section D may be referred to as a discharge section D[m]. The variable m is an integer of 1 or more and M or less. Further, when a component, a signal, or the like of the ink jet printer 1 corresponds to the stage number m of the discharge section D[m], a reference numeral for representing the component, the signal, or the like may be represented by adding a suffix [m] indicating that the component, the signal, or the like corresponds to the stage number m.

The switching circuit 10 switches whether or not to supply the drive signal Com output from the drive signal generation circuit 2 to each discharge section D. The switching circuit 10 switches whether or not to electrically couple each discharge section D and the detection circuit 20.

The detection circuit 20 generates a residual vibration signal NES[m] indicating vibration remaining in the discharge section D[m] after the discharge section D[m] is driven, based on a detection signal Vout[m] that is detected from the discharge section D[m] driven in response to the drive signal Com. Hereinafter, the vibration is referred to as “residual vibration”.

The ink jet printer 1 according to the present embodiment executes a discharge state determination process of determining whether or not the discharge state of the ink I from the discharge section D is normal. In the discharge state determination process, the measurement circuit 9 generates determination information Stt[m] indicating whether or not the discharge state of the ink I from the discharge section D[m] is normal, based on the residual vibration signal NES[m]. Hereinafter, in the discharge state determination process, a process of generating, via the measurement circuit 9, the determination information Stt[m] based on the residual vibration signal NES[m] may be referred to as the discharge state determination process. Hereinafter, the discharge section D that is a target of the discharge state determination of the measurement circuit 9 may be referred to as a determination target discharge section D-H.

Further, the measurement circuit 9 generates phase information NtF[m] indicating a phase of the residual vibration in the discharge section D[m] based on the residual vibration signal NES[m] in the discharge state determination process. Generally, the phase of the residual vibration in the discharge section D[m] varies in accordance with the viscosity of the ink I filled in the discharge section D[m]. Therefore, the phase information NtF[m] indicates a value corresponding to the viscosity of the ink I filled in the discharge section D[m]. Therefore, in the present embodiment, the phase information NtF[m] is adopted as “viscosity information,” which is information on the viscosity of the ink I filled in the discharge section D[m].

In the present embodiment, it is assumed that the ink jet printer 1 is a serial printer. Specifically, the ink jet printer 1 executes the print process by discharging the ink I from the discharge section D while transporting the recording paper Pp in a sub-scanning direction and moving the head unit HU in a main scanning direction as illustrated in FIG. 2. In the present embodiment, as illustrated in FIG. 2, a +X direction and a −X direction, which is a direction opposite to the +X direction, are the main scanning directions, and a +Y direction is the sub-scanning direction. Hereinafter, the +X direction and the −X direction are collectively referred to as an “X axis direction”, and hereinafter, the +Y direction and a −Y direction, which is a direction opposite to the +Y direction, are collectively referred to as a “Y axis direction”. Further, a direction, which is perpendicular to the X axis direction and the Y axis direction and is a discharge direction of the ink I, is referred to as a −Z direction. The −Z direction and a +Z direction, which is a direction opposite to the −Z direction, are collectively referred to as a “Z axis direction”.

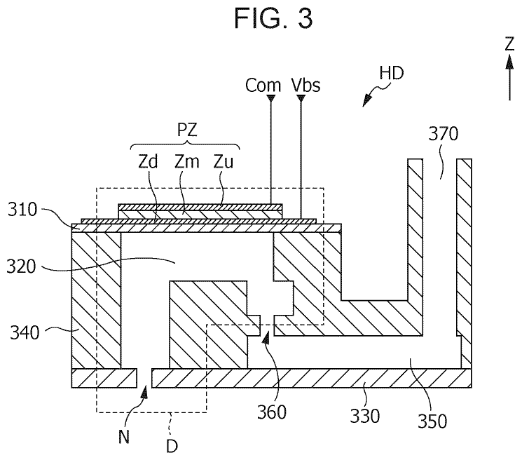

The recording head HD and the discharge section D provided at the recording head HD will be described with reference to FIG. 3.

FIG. 3 is a schematic partial cross-sectional view of the recording head HD, in which the recording head HD is cut such that the discharge section D is included.

As illustrated in FIG. 3, the discharge section D includes a piezoelectric element PZ, a cavity 320 filled with the ink I, a nozzle N communicating with the cavity 320, and a vibrating plate 310. The cavity 320 is an example of a “pressure chamber”. The discharge section D discharges the ink I in the cavity 320 from the nozzle N by supplying the drive signal Com to the piezoelectric element PZ to drive the piezoelectric element PZ in response to the drive signal Com. The cavity 320 is a space defined by a cavity plate 340, a nozzle plate 330 at which the nozzle N is formed, and the vibrating plate 310. The cavity 320 communicates with a reservoir 350 through an ink supply port 360. The reservoir 350 communicates with a liquid container 14 corresponding to the discharge section D through an ink intake port 370.

In the present embodiment, a unimorph type as illustrated in FIG. 3 is adopted as the piezoelectric element PZ. The piezoelectric element PZ is not limited to the unimorph type, and a bimorph type, a laminated type, or the like may be adopted.

The piezoelectric element PZ has an upper electrode Zu, a lower electrode Zd, and a piezoelectric body Zm provided between the upper electrode Zu and the lower electrode Zd. The piezoelectric element PZ is a passive element that is deformed in accordance with the potential change of the drive signal Com. When a voltage is applied between the upper electrode Zu and the lower electrode Zd by electrically coupling the lower electrode Zd to a feeder line LHd, which is set to a constant potential VBS, and supplying the drive signal Com to the upper electrode Zu, the piezoelectric element PZ is displaced in the +Z direction or the −Z direction in accordance with the applied voltage, and the piezoelectric element PZ vibrates as a result of the displacement.

The vibrating plate 310 is installed in an upper surface opening portion of the cavity plate 340. The lower electrode Zd is joined to the vibrating plate 310. Therefore, when the piezoelectric element PZ vibrates by being driven in response to the drive signal Com, the vibrating plate 310 also vibrates. A volume of the cavity 320 is changed due to the vibration of the vibrating plate 310, and the ink I filled in the cavity 320 is discharged from the nozzle N. When the ink I in the cavity 320 is decreased by discharging the ink I, the ink I is supplied from the reservoir 350.

The transport mechanism 7 transports the recording paper Pp in the +Y direction. Specifically, the transport mechanism 7 is provided with a transport roller (not illustrated) of which a rotation axis is parallel to the X axis direction, and a motor (not illustrated) that rotates the transport roller under the control of the control section 6.

The moving mechanism 8 reciprocates the head unit HU along the X axis under the control of the control section 6. As illustrated in FIG. 2, the moving mechanism 8 includes a transport body 82 that has a substantially box shape and accommodates the head unit HU, and an endless belt 81 to which the transport body 82 is fixed.

The maintenance unit 4 includes a cap 42 for covering each head unit HU such that the nozzle N of the discharge section D is sealed, a wiper 44 for wiping off a foreign matter such as paper dust adhering to the vicinity of the nozzle N of the discharge section D, a tube pump (not illustrated) for suctioning the ink I, air bubbles, or the like in the discharge section D, and a discharge ink reception portion (not illustrated) for receiving the discharged ink I when the ink I in the discharge section D is discharged. The maintenance unit 4 is provided in a region that does not overlap with the recording paper Pp when seen in the Z axis direction.

The storage section 5 includes a volatile memory such as RAM and a non-volatile memory such as a ROM, an EEPROM, or a PROM, and stores various information such as the print data Img supplied from the host computer and the control program of the ink jet printer 1. RAM is an abbreviation for random access memory. ROM is an abbreviation for read only memory. EEPROM is an abbreviation for electrically erasable programmable read-only memory. PROM is an abbreviation for programmable ROM.

The control section 6 includes a CPU. CPU is an abbreviation for central processing unit. However, the control section 6 may include a programmable logic device such as an FPGA instead of the CPU. FPGA is an abbreviation for field programmable gate array.

When the CPU provided in the control section 6 operates according to the control program stored in the storage section 5, the ink jet printer 1 executes the print process and the maintenance process.

The control section 6 executes the control program stored in the storage section 5 and operates according to the control program, to function as a drive control section 61, a discharge control section 62, a discharge amount determination section 63, an acquisition section 64, and a generation section 65.

The drive control section 61 generates a waveform designation signal dCom for controlling the drive signal generation circuit 2. The discharge control section 62 generates a print signal SI for controlling the head unit HU. The control section 6 generates a signal for controlling the transport mechanism 7 and a signal for controlling the moving mechanism 8.

Here, the waveform designation signal dCom is a digital signal for defining a waveform of the drive signal Com. The drive signal Com is an analog signal for driving the discharge section D. The drive signal generation circuit 2 includes a DA conversion circuit and generates the drive signal Com having the waveform defined by the waveform designation signal dCom. In the present embodiment, it is assumed that the drive signal Com includes a drive signal Com-A and a drive signal Com-B.

Further, the print signal SI is a digital signal for designating a type of an operation of the discharge section D. Specifically, the print signal SI designates the type of the operation of the discharge section D by designating whether or not to supply the drive signal Com to the discharge section D. The designation of the type of the operation of the discharge section D is, for example, the designation of whether or not to drive the discharge section D, the designation of whether or not to discharge the ink I from the discharge section D when the discharge section D is driven, or the designation of an amount of ink discharged from the discharge section D when the discharge section D is driven.

When the print process is executed, the discharge control section 62 first stores the print data Img supplied from the host computer in the storage section 5. Next, the discharge control section 62 generates various control signals such as the print signal SI, the waveform designation signal dCom, the signal for controlling the transport mechanism 7, and the signal for controlling the moving mechanism 8, based on various data such as the print data Img stored in the storage section 5. The discharge control section 62 controls the head unit HU such that the discharge section D is driven, while controlling the transport mechanism 7 and the moving mechanism 8 such that a relative position of the recording paper Pp with respect to the head unit HU is changed, based on various control signals and various data stored in the storage section 5. As a result, the discharge control section 62 adjusts the presence or absence of discharge of the ink I from the discharge section D, a discharge amount of the ink I, a discharge timing of the ink I, and the like, and controls the execution of the print process of forming the image corresponding to the print data Img on the recording paper Pp.

As described above, the ink jet printer 1 according to the present embodiment executes the discharge state determination process of determining whether or not the discharge state of the ink I from the discharge section D is normal.

In the discharge state determination process, the ink jet printer 1 executes the series of processes including a first process, a second process, a third process, a fourth process, a fifth process, a sixth process, and a seventh process, as illustrated below. In the first process, the control section 6 selects the determination target discharge section D-H from among the M discharge sections D provided in the head unit HU. In the second process, the control section 6 generates the residual vibration in the determination target discharge section D-H by driving the determination target discharge section D-H. In the third process, the detection circuit 20 generates the residual vibration signal NES based on the detection signal Vout detected from the determination target discharge section D-H. In the fourth process, the measurement circuit 9 executes the discharge state determination process targeting for the determination target discharge section D-H based on the residual vibration signal NES, and generates the determination information Stt indicating a result of the determination. In the fifth process, the control section 6 stores the determination information Stt in the storage section 5. In the sixth process, the measurement circuit 9 generates the phase information NtF based on the residual vibration signal NES. In the seventh process, the control section 6 stores the phase information NtF in the storage section 5.

As described above, the ink jet printer 1 according to the present embodiment executes the maintenance process of restoring the discharge state of the ink I in the discharge section D having a discharge abnormality to a normal state.

Further, the ink jet printer 1 according to the present embodiment executes the maintenance process of bringing the viscosity of the ink I for the discharge section D within an appropriate range in all the M discharge sections D before the print process and after the print process.

Specifically, the maintenance process is a process of restoring the discharge state of the ink I in the discharge section D to a normal state by executing one or a plurality of a wiping process, a pumping process, and an ink discharge process. The wiping process is a process of wiping off the foreign matter such as paper dust adhering to the vicinity of the nozzle N of the discharge section D with the wiper 44. The pumping process is a process of suctioning the ink I, air bubbles, or the like in the discharge section D with the tube pump. The ink discharge process is a process of driving the discharge section D to discharge the ink I from the discharge section D. The ink jet printer 1 executes a flushing process for one or a plurality of times in the ink discharge process. Further, the ink jet printer 1 executes a flushing operation for one or a plurality of times in the flushing process. Hereinafter, in the flushing process, the number of times of execution of the flushing operation may be referred to as “the number of shots FC”. In the following description, the number of shots FC may be denoted as the number of shots FCx using one or more characters x in order to indicate that the number of shots FCx is a specific value of the number of shots FC. In the present embodiment, it is assumed that an amount of the ink I discharged from the nozzle N in the flushing operation for one number of shots FC is equal.

In FIG. 1, the discharge amount determination section 63 determines the amount of the ink I discharged from the discharge section D in the flushing process according to the present embodiment.

The acquisition section 64 acquires the determination information Stt[m] indicating the result of the discharge state determination of the discharge section D[m] and the phase information NtF[m] indicating the phase of the residual vibration in the discharge section D[m] from the measurement circuit 9. More specifically, the acquisition section 64 acquires the phase information NtF1[m] indicating the phase of the residual vibration in the discharge section D[m]. In addition, after the discharge control section 62 causes the discharge section D[m] to discharge a first amount of the ink I by executing the flushing operation for one or a plurality of times, the acquisition section 64 acquires the phase information NtF2[m] indicating the phase of the residual vibration in the discharge section D[m]. As described above, the phase information NtF1[m] and the phase information NtF2[m] indicate values corresponding to the viscosity of the ink I filled in the discharge section D[m]. In the present embodiment, the phase information NtF1[m] is an example of “first viscosity information,” and the phase information NtF2[m] is an example of “second viscosity information”.

The generation section 65 generates difference information DF indicating a difference between the phase corresponding to the viscosity indicated by the first phase information NtF1[m] and the phase corresponding to the viscosity indicated by the second phase information NtF2[m].

The discharge control section 62 causes the discharge section D in which the difference indicated by the difference information DF is equal to or greater than a predetermined value among a plurality of discharge sections D, to discharge the first amount of the ink I again. On the other hand, the discharge control section 62 causes the discharge section D in which the difference indicated by the difference information DF is less than the predetermined value among the plurality of discharge sections D, not to discharge the ink I.

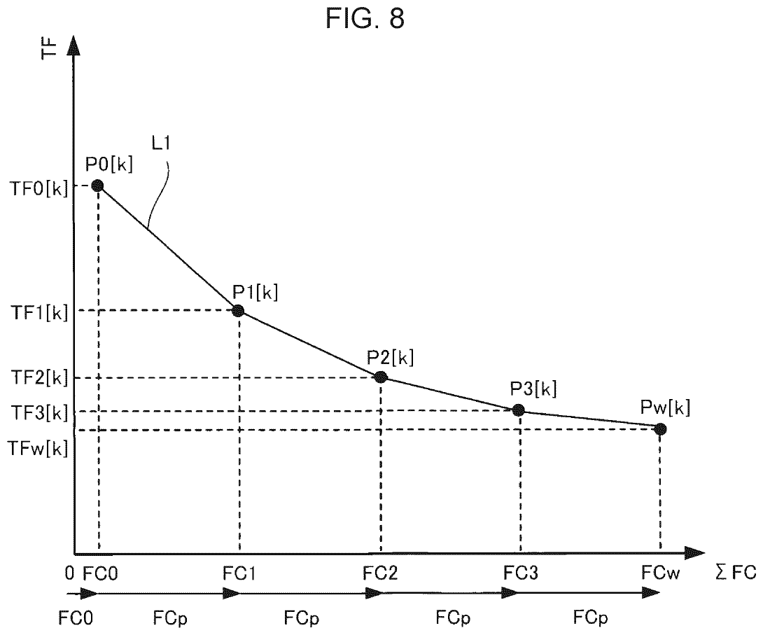

Details of the operations of the discharge control section 62, the discharge amount determination section 63, the acquisition section 64, and the generation section 65 will be described below with reference mainly to FIGS. 8, 9, and 10.

### 1-2: Configuration of Head Unit HU

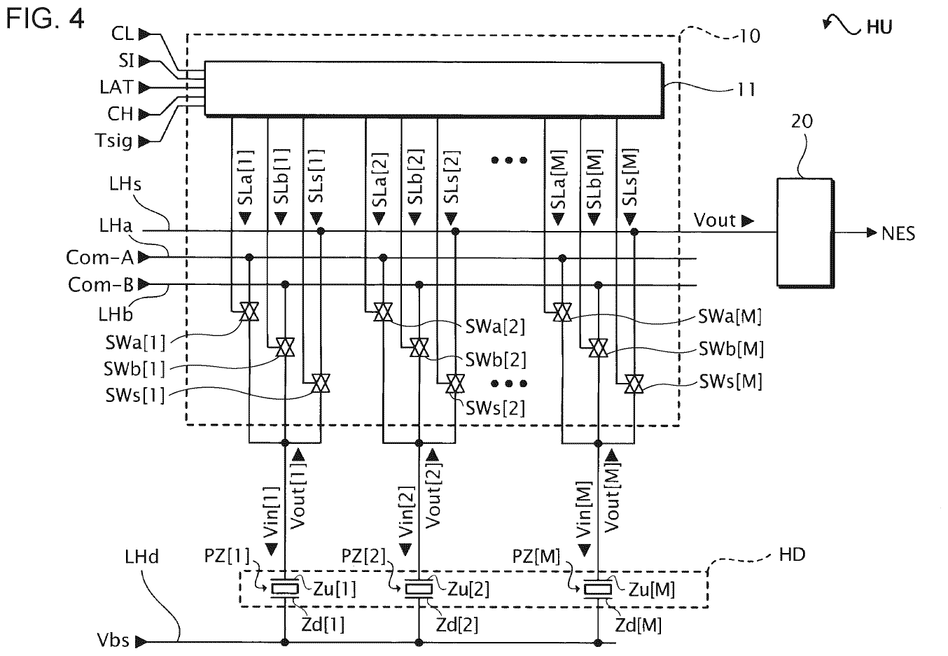

Hereinafter, a configuration of the head unit HU will be described with reference to FIG. 4.

FIG. 4 is a block diagram illustrating an example of the configuration of the head unit HU. As described above, the head unit HU includes the recording head HD, the switching circuit 10, and the detection circuit 20. The head unit HU includes an internal wiring LHa to which the drive signal Com-A is supplied from the drive signal generation circuit 2, an internal wiring LHb to which the drive signal Com-B is supplied from the drive signal generation circuit 2, and an internal wiring LHs for supplying the detection signal Vout detected from the discharge section D to the detection circuit 20.

As illustrated in FIG. 4, the switching circuit 10 includes M switches SWa[1] to SWa[M], M switches SWb[1] to SWb[M], M switches SWs[1] to SWs[M], and a coupling state designation circuit 11 that designates a coupling state of each switch. As each switch, for example, a transmission gate can be adopted.

The coupling state designation circuit 11 generates coupling state designation signals SLa[1] to SLa[M] for designating turning on or off of the switches SWa[1] to SWa[M], coupling state designation signals SLb[1] to SLb[M] for designating turning on or off of the switches SWb[1] to SWb[M], and coupling state designation signals SLs[1] to SLs[M] for designating turning on or off of the switches SWs[1] to SWs[M] based on at least some of signals of the print signal SI, a latch signal LAT, a change signal CH, and a period designation signal Tsig which are supplied from the control section 6.

The switch SWa[m] switches between conduction and non-conduction between the internal wiring LHa and the upper electrode Zu[m] of the piezoelectric element PZ[m] provided in the discharge section D[m] in response to the coupling state designation signal SLa[m]. For example, the switch SWa[m] is turned on when the coupling state designation signal SLa[m] is at a high level, and is turned off when the coupling state designation signal SLa[m] is at a low level.

The switch SWb[m] switches between conduction and non-conduction between the internal wiring LHb and the upper electrode Zu[m] of the piezoelectric element PZ[m] provided in the discharge section D[m] in response to the coupling state designation signal SLb[m]. For example, the switch SWb[m] is turned on when the coupling state designation signal SLb[m] is at a high level, and is turned off when the coupling state designation signal SLb[m] is at a low level.

Among the drive signals Com-A and Com-B, the signal that is actually supplied to the piezoelectric element PZ[m] of the discharge section D[m] via the switch SWa[m] or SWb[m] may be referred to as a supply drive signal Vin[m].

The switch SWs[m] switches between conduction and non-conduction between the internal wiring LHs and the upper electrode Zu[m] of the piezoelectric element PZ[m] provided in the discharge section D[m] in response to the coupling state designation signal SLs[m]. For example, the switch SWs[m] is turned on when the coupling state designation signal SLs[m] is at a high level, and is turned off when the coupling state designation signal SLs[m] is at a low level.

The detection circuit 20 is supplied with the detection signal Vout[m], which is output from the piezoelectric element PZ[m] of the discharge section D[m] driven as the determination target discharge section D-H, through the internal wiring LHs. Thereafter, the detection circuit 20 generates the residual vibration signal NES based on the detection signal Vout[m].

### 1-3: Operation of Head Unit HU

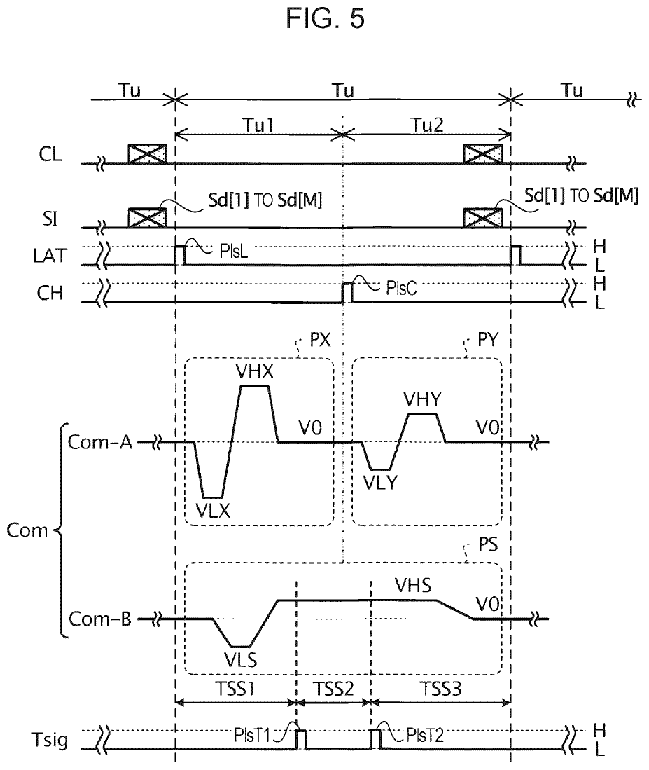

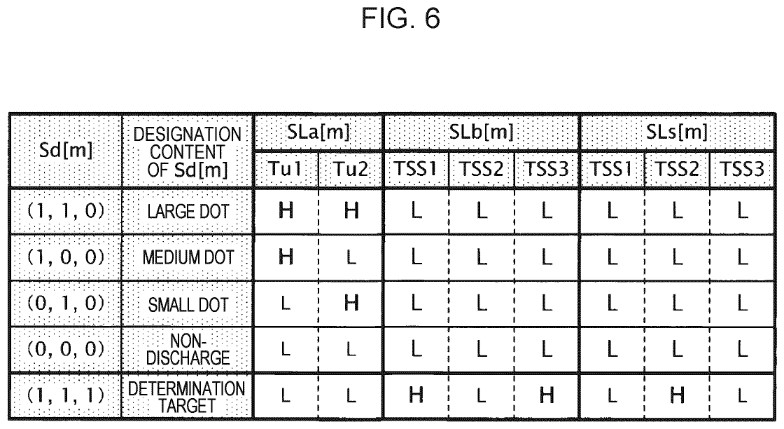

Hereinafter, the operation of the head unit HU will be described with reference to FIGS. 5 and 6.

In the present embodiment, an operation period of the ink jet printer 1 includes one or a plurality of unit periods Tu. It is assumed that the ink jet printer 1 according to the present embodiment executes, in each unit period Tu, one of the driving of each discharge section D in the print process, the driving of each discharge section D in the flushing process, the driving of the determination target discharge section D-H and the detection of the residual vibration in a preparation process of the discharge state determination process. However, the present disclosure is not limited to such an aspect, and both of the driving of each discharge section D in the print process, and the driving of the determination target discharge section D-H and the detection of the residual vibration in the preparation process of the discharge state determination process may be executable in each unit period Tu.

Generally, the ink jet printer 1 forms the image indicated by the print data Img by repeating the print process over a plurality of consecutive or intermittent unit periods Tu to discharge the ink I one or a plurality of times from each discharge section D. Further, the ink jet printer 1 according to the present embodiment executes the discharge state determination process in which each of the M discharge sections D[1] to D[M] is used as the determination target discharge section D-H by executing the preparation process of the discharge state determination process for M times in the M consecutive or intermittent unit periods Tu.

FIG. 5 is a timing chart illustrating the operation of the ink jet printer 1 in the unit period Tu.

As illustrated in FIG. 5, the control section 6 outputs the latch signal LAT having a pulse PlsL and the change signal CH having a pulse PlsC. As a result, the control section 6 defines the unit period Tu as a period from the rise of the pulse PlsL to the rise of the next pulse PlsL. The control section 6 divides the unit period Tu into two control periods Tu1 and Tu2 by the pulse PlsC.

The print signal SI includes individual designation signals Sd[1] to Sd[M] for designating the driving aspects of the discharge sections D[1] to D[M] in each unit period Tu. When at least one of the print process and the discharge state determination process is executed in the unit period Tu, the control section 6 supplies the print signal SI including the individual designation signals Sd[1] to Sd[M] to the coupling state designation circuit 11 in synchronization with a clock signal CL before the start of the unit period Tu, as illustrated in FIG. 4. In this case, the coupling state designation circuit 11 generates the coupling state designation signals SLa[m], SLb[m], and SLs[m] based on the individual designation signal Sd[m] in the unit period Tu.

The individual designation signal Sd[m] according to the present embodiment is a signal for designating any one of the five driving aspects including the discharge of the ink I in an amount corresponding to a large dot, the discharge of the ink I in an amount corresponding to a medium dot, the discharge of the ink I in an amount corresponding to a small dot, non-discharge of the ink I, and the driving as the determination target in the discharge state determination process, for the discharge section D[m] in each unit period Tu. In the following description, an amount corresponding to the large dot may be referred to as a “large amount”, and the discharge of the ink I in the amount corresponding to the large dot may be referred to as “formation of the large dot”. Similarly, the amount corresponding to the medium dot may be referred to as a “medium amount”, and the discharge of the ink I in the amount corresponding to the medium dot may be referred to as “formation of the medium dot”. The amount corresponding to a small dot may be referred to as a “small amount”, and the discharge of the ink I in the amount corresponding to the small dot may be referred to as “formation of the small dot”. The driving as the determination target in the discharge state determination process may be referred to as “driving as the determination target discharge section D-H”. In the present embodiment, as an example, it is assumed that the individual designation signal Sd[m] is a 3-bit digital signal as illustrated in FIG. 6.

In the present disclosure, the “discharge of the ink I in the amount corresponding to the large dot” corresponds to the flushing operation.

As illustrated in FIG. 5, the drive signal generation circuit 2 outputs the drive signal Com-A having a medium dot waveform PX provided in the control period Tu1 and a small dot waveform PY provided in the control period Tu2. In the present embodiment, the medium dot waveform PX and the small dot waveform PY are determined such that a potential difference between a maximum potential VHX and a minimum potential VLX of the medium dot waveform PX is greater than a potential difference between a maximum potential VHY and a minimum potential VLY of the small dot waveform PY. Specifically, when the discharge section D[m] is driven in response to the drive signal Com-A having the medium dot waveform PX, the medium dot waveform PX is determined such that the medium amount of the ink I is discharged from the discharge section D[m]. In addition, when the discharge section D[m] is driven in response to the drive signal Com-A having the small dot waveform PY, the small dot waveform PY is determined such that the small amount of the ink I is discharged from the discharge section D[m]. The potentials at the start and the end of the medium dot waveform PX and the small dot waveform PY are set to a reference potential VO.

When the individual designation signal Sd[m] designates the formation of the large dot for the discharge section D[m], the coupling state designation circuit 11 sets the coupling state designation signal SLa[m] to a high level in the control periods Tu1 and Tu2, and sets the coupling state designation signals SLb[m] and SLs[m] to a low level in the unit period Tu. In this case, the discharge section D[m] is driven in response to the drive signal Com-A of the medium dot waveform PX to discharge the medium amount of the ink I in the control period Tu1, and is driven in response to the drive signal Com-A of the small dot waveform PY to discharge the small amount of the ink I in the control period Tu2. As a result, the discharge section D[m] discharges the large amount of the ink I in total in the unit period Tu, and the large dot is formed on the recording paper Pp.

In addition, when the individual designation signal Sd[m] designates the formation of the medium dot for the discharge section D[m], the coupling state designation circuit 11 sets the coupling state designation signal SLa[m] to a high level in the control period Tu1 and to a low level in the control period Tu2, and sets the coupling state designation signals SLb[m] and SLs[m] to a low level in the unit period Tu. In this case, the discharge section D[m] discharges the medium amount of the ink I in the unit period Tu, and the medium dot is formed on the recording paper Pp.

In addition, when the individual designation signal Sd[m] designates the formation of the small dot for the discharge section D[m], the coupling state designation circuit 11 sets the coupling state designation signal SLa[m] to a low level in the control period Tu1 and to a high level in the control period Tu2, and sets the coupling state designation signals SLb[m] and SLs[m] to a low level in the unit period Tu. In this case, the discharge section D[m] discharges the small amount of the ink I in the unit period Tu, and the small dot is formed on the recording paper Pp.

In addition, when the individual designation signal Sd[m] designates the non-discharge of the ink I for the discharge section D[m], the coupling state designation circuit 11 sets the coupling state designation signals SLa[m], SLb[m], and SLs[m] to a low level in the unit period Tu. In this case, the discharge section D[m] does not discharge the ink I and does not form the dot on the recording paper Pp in the unit period Tu.

As illustrated in FIG. 5, the drive signal generation circuit 2 outputs the drive signal Com-B having an inspection waveform PS provided in the unit period Tu. In the present embodiment, the inspection waveform PS is determined such that a potential difference between a maximum potential VHS and a minimum potential VLS of the inspection waveform PS is less than a potential difference between the maximum potential VHY and the minimum potential VLY of the small dot waveform PY. Specifically, when the drive signal Com-B having the inspection waveform PS is supplied to the discharge section D[m], the inspection waveform PS is determined such that the discharge section D[m] is driven to the extent that the ink I is not discharged from the discharge section D[m]. The potential at the start and the end of the inspection waveform PS is set to the reference potential VO.

Further, the control section 6 outputs the period designation signal Tsig having a pulse PlsT1 and a pulse PlsT2. As a result, the control section 6 divides the unit period Tu into a control period TSS1 from the start of the pulse PlsL to the start of the pulse PlsT1, a control period TSS2 from the start of the pulse PlsT1 to the start of the pulse PlsT2, and a control period TSS3 from the start of pulse PlsT2 to the start of the next pulse PlsL.

When the individual designation signal Sd[m] designates the discharge section D[m] as the determination target discharge section D-H, the coupling state designation circuit 11 sets the coupling state designation signal SLa[m] to a low level in the unit period Tu, sets the coupling state designation signal SLb[m] to a high level in the control periods TSS1 and TSS3 and to a low level in the control period TSS2, and sets the coupling state designation signal SLs[m] to a low level in the control periods TSS1 and TSS3 and to a high level in the control period TSS2.

In this case, the determination target discharge section D-H is driven in response to the drive signal Com-B of the inspection waveform PS in the control period TSS1. Specifically, the piezoelectric element PZ included in the determination target discharge section D-H is displaced in response to the drive signal Com-B of the inspection waveform PS in the control period TSS1. As a result, the vibration is generated in the determination target discharge section D-H, and this vibration remains even in the control period TSS2. In the control period TSS2, the upper electrode Zu included in the piezoelectric element PZ of the determination target discharge section D-H changes the potential in accordance with the residual vibration generated in the determination target discharge section D-H. In other words, in the control period TSS2, the upper electrode Zu included in the piezoelectric element PZ of the determination target discharge section D-H indicates a potential corresponding to an electromotive force of the piezoelectric element PZ caused by the residual vibration generated in the determination target discharge section D-H. The potential of the upper electrode Zu can be detected as the detection signal Vout in the control period TSS2.

FIG. 6 is an explanatory diagram illustrating the generation of the coupling state designation signals SLa[m], SLb[m], and SLs[m]. The coupling state designation circuit 11 decodes the individual designation signal Sd[m] according to FIG. 6, and generates the coupling state designation signals SLa[m], SLb[m], and SLs[m].

As illustrated in FIG. 6, the individual designation signal Sd[m] according to the present embodiment indicates any one of a value (1, 1, 0) that designates the formation of the large dot, a value (1, 0, 0) that designates the formation of the medium dot, a value (0, 1, 0) that designates the formation of the small dot, a value (0, 0, 0) that designates the non-discharge of the ink I, or a value (1, 1, 1) that designates the driving as the determination target discharge section D-H. Then, the coupling state designation circuit 11 sets the coupling state designation signal SLa[m] to a high level in the control periods Tu1 and Tu2 when the individual designation signal Sd[m] indicates (1, 1, 0), sets the coupling state designation signal SLa[m] to a high level in the control period Tu1 when the individual designation signal Sd[m] indicates (1, 0, 0), sets the coupling state designation signal SLa[m] to a high level in the control period Tu2 when the individual designation signal Sd[m] indicates (0, 1, 0), sets the coupling state designation signal SLb[m] to a high level in the control periods TSS1 and TSS3 and sets the coupling state designation signal SLs[m] to a high level in the control period TSS2 when the individual designation signal Sd[m] indicates (1, 1, 1), and sets each signal to a low level in other cases.

The detection circuit 20 generates the residual vibration signal NES based on the detection signal Vout as described above. The residual vibration signal NES is a signal obtained by amplifying an amplitude of the detection signal Vout and removing a noise component from the detection signal Vout, and is a signal obtained by shaping the detection signal Vout into a waveform suitable for the process in the measurement circuit 9. The residual vibration signal NES is an analog signal.

The detection circuit 20 may have a configuration including, for example, a negative feedback type amplifier for amplifying the detection signal Vout, a low-pass filter for attenuating a high frequency component of the detection signal Vout, and a voltage follower that converts impedance and outputs the residual vibration signal NES having low impedance.

### 1-4: Operation of Measurement Circuit 9

Next, the measurement circuit 9 will be described.

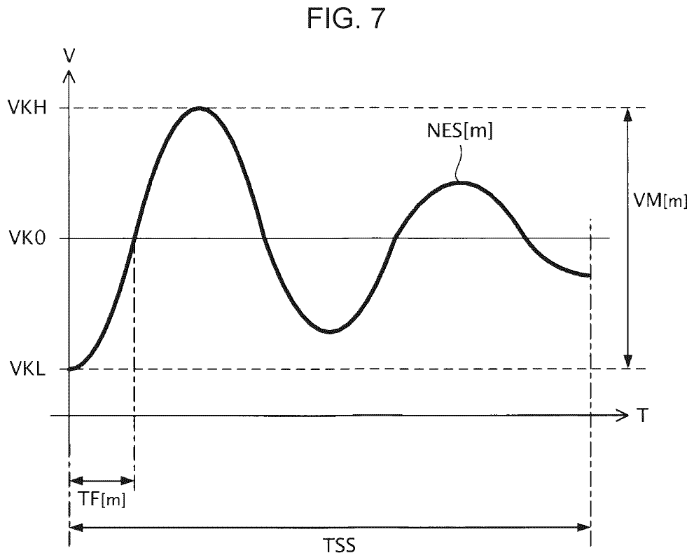

Generally, the residual vibration generated in the discharge section D is determined by a shape of the nozzle N, a weight of the ink I filled in the cavity 320, the viscosity of the ink I filled in the cavity 320, and the like. FIG. 7 is an explanatory diagram illustrating an example of the residual vibration signal NES supplied by the detection circuit 20 to the measurement circuit 9.

As illustrated in FIG. 7, the detection circuit 20 outputs the residual vibration signal NES[m] in a detection period TSS. The residual vibration signal NES[m] illustrates a waveform based on the residual vibration of the discharge section D[m] in the detection period TSS.

Specifically, the residual vibration signal NES[m] indicates the vibration that attenuates between a minimum potential VKL and a maximum potential VKH.

In the present embodiment, the measurement circuit 9 measures an amplitude VM[m] of the residual vibration signal NES[m] and an initial time TF[m].

Here, the amplitude VM[m] is a value corresponding to the amplitude of the residual vibration signal NES[m]. Specifically, in the present embodiment, the residual vibration signal NES[m] is a potential difference between the maximum potential VKH and the minimum potential VKL.

In the present embodiment, the initial time TF[m] is a time length from a start time of the detection period TSS to a time when the potential of the residual vibration signal NES[m] is a predetermined reference potential VK0. Here, the reference potential VK0 may be, for example, a potential that is a center of the amplitude of the residual vibration signal NES[m].

Further, the measurement circuit 9 outputs the phase information NtF[m] indicating the measured initial time TF[m]. Generally, the initial time TF[m] has a time length corresponding to the viscosity of the ink I in the discharge section D[m]. Therefore, in the present embodiment, the phase information NtF[m] is adopted as the viscosity information that is information on the viscosity. In the present application, as an example, it is assumed that the initial time TF[m] is decreased as the viscosity of the ink I in the discharge section D[m] is decreased.

In the present embodiment, the measurement circuit 9 generates the determination information Stt[m] indicating that the discharge state of the discharge section D[m] is normal when the amplitude VM[m] satisfies an amplitude determination condition that is equal to or greater than a threshold value VM-L and equal to or less than a threshold value VM-H and the initial time TF[m] satisfies a phase determination condition that is equal to or greater than a threshold value TF-L and equal to or less than a threshold value TF-H, in the discharge state determination process targeting for the discharge section D[m]. On the other hand, the measurement circuit 9 generates the determination information Stt[m] indicating that the discharge state in the discharge section D[m] is abnormal when the amplitude VM[m] does not satisfy the amplitude determination condition or when the initial time TF[m] does not satisfy the phase determination condition.

The threshold value VM-L and the threshold value VM-H are real numbers of “0<VM-L<VM-H,” and the threshold value TF-L and the threshold value TF-H are real numbers of “0<TF-L<TF-H”.

### 1-5: Ink Discharge Process

Next, the ink discharge process according to the present embodiment will be described.

Since a degree of thickening of the ink I is affected by many factors such as a temperature and the humidity in the surroundings of the discharge section D, the type of the ink I, a variation in a nozzle diameter in the discharge section D, a print pattern, and the like, it is difficult to determine a necessary discharge amount of the ink I depending on a situation to which the discharge section D is exposed so far each time the ink discharge process is executed. Therefore, in the related art, the amount of the ink I discharged in the ink discharge process is determined to a predetermined amount set in advance.

However, in a method of discharging the predetermined amount of the ink I set in advance in the ink discharge process, there are the following two issues.

First, an evaporation amount of moisture in the ink I is affected by many factors such as the temperature and the humidity in the surroundings of the discharge section D and an elapsed time from the previous flushing process, and thus the discharge amount may be excessive or insufficient depending on a situation in which the discharge section D is exposed in the ink discharge process of discharging the predetermined amount set in advance. For example, when the amount of the ink I discharged in the ink discharge process is set by assuming a situation in which the evaporation amount of moisture is the largest such that a deterioration in a print quality in the print process after the ink discharge process due to an insufficient amount of the ink I discharged in the ink discharge process and the thickened ink I in the discharge section D not being able to be discharged is prevented from occurring, the ink I is excessively discharged in the ink discharge process in a situation in which the evaporation amount of moisture is not large, resulting in the ink I being wasted. In addition, when the discharge section D is exposed to a situation in which moisture in the ink I in the discharge section D is evaporated in an amount equal to or greater than an amount assumed when the predetermined amount is set, the ink discharge amount in the ink discharge process is insufficient, and the thickened ink I in the discharge section D cannot be discharged, resulting in the deterioration of the print quality in the print process after the ink discharge process.

Second, in the ink jet printer of the related art, the flushing process of causing the plurality of discharge sections D included in the head unit HU to discharge the same amount of the ink I uniformly is executed. Therefore, when the evaporation amounts of moisture from the ink I filled in the plurality of discharge sections D are different from each other, the discharge amount of the ink I may be excessive or insufficient depending on the discharge section D. For example, when a usage frequency is different between the plurality of discharge sections D in the print process before the ink discharge process, the ink I may be excessively discharged and the ink I may be wasted in the discharge section D having a low usage frequency, or the ink I may be discharged insufficiently and the print quality may deteriorate in the discharge section D having a high usage frequency. In addition, for example, when the situation such as the temperature and the humidity in the surroundings of the discharge section D, the type of the ink I, and the nozzle diameter in the discharge section D, or the like is different depending on a disposition position of each of the plurality of discharge sections D, the ink I is excessively discharged and the ink I is wasted in the discharge section D in which the evaporation of moisture from the filled ink I is small, or the ink I is discharged insufficiently and the print quality deteriorates in the discharge section D in which the evaporation of moisture from the filled ink I is large.

Therefore, in the present embodiment, the control section 6 increases the number of flushing operations in the discharge section D[m] in which the evaporation amount of moisture from the ink I is large at the start of the ink discharge process to be larger than the number of flushing operations in the discharge section D[m] in which the evaporation amount of moisture from the ink I is small at the start of the ink discharge process. Specifically, the control section 6 acquires the phase information NtF[m] corresponding to the viscosity of the ink I in each discharge section D[m] before and after the flushing process as described above. Further, the control section 6 controls, for each discharge section D[m], whether to discharge the ink I again via the flushing process or not to discharge the ink I, in accordance with the difference between the phase indicated by the first phase information NtF1[m] acquired before the flushing process and the phase indicated by the second phase information NtF2[m] acquired after the flushing process. More specifically, the control section 6 controls, for each discharge section D[m], whether or not to further execute the flushing process including the flushing operations for a plurality of times, in accordance with the difference in the phase information NtF[m] acquired before and after the flushing process.

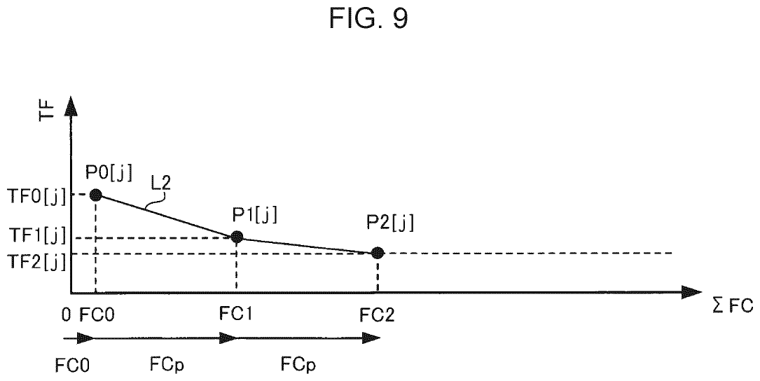

FIG. 8 is an explanatory diagram illustrating an ink discharge process for one discharge section D[k] of the plurality of discharge sections D, and FIG. 9 is an explanatory diagram illustrating the ink discharge process for another discharge section D[j] other than the discharge section D[k] of the plurality of discharge sections D. A case will be described in which the evaporation amount of moisture from the ink I in the discharge section D[j] is less than the evaporation amount of moisture from the ink I in the discharge section D[k] at the start of the ink discharge process. The variable k is an integer of 1 or more and M or less. The variable j is an integer of 1 or more and M or less.

Specifically, FIG. 8 is a graph illustrating a relationship line L1 indicating a relationship between the number of flushing operations (number of shots FCp) in each flushing process for one or a plurality of times included in the ink discharge process for the discharge section D[k] and an initial time TF[k] indicated by phase information NtF[k], which is the viscosity information acquired in the discharge state determination process executed for the discharge section D[k] at the start and the end of each flushing process. FIG. 9 is a graph illustrating a relationship line L2 indicating a relationship between the number of flushing operations (number of shots FCp) in each flushing process for one or a plurality of times included in the ink discharge process for the discharge section D[j] and an initial time TF[j] indicated by phase information NtF[j], which is the viscosity information acquired in the discharge state determination process executed for the discharge section D[j] at the start and the end of each flushing process.

Specifically, a horizontal axis represents the cumulative number of times of the flushing operation executed by the discharge section D[k] in the ink discharge process in the graph of FIG. 8, and represents the cumulative number of times of the flushing operation executed by the discharge section D[j] in the ink discharge process in the graph of FIG. 9. Hereinafter, the cumulative number of times is referred to as a cumulative number of shots EFC.

In addition, a vertical axis represents the initial time TF indicated by the phase information NtF[k] acquired in each of the discharge state determination processes for a plurality of times executed during the ink discharge process in the graph of FIG. 8, and represents the initial time TF indicated by the phase information NtF[j] acquired in each of the discharge state determination processes for a plurality of times executed during the ink discharge process in the graph of FIG. 9.

In FIGS. 8 and 9, the relationship lines L1 and L2 are illustrated by polygonal lines, but the relationship lines L1 and L2 may be curved lines.

In addition, in FIG. 8, each of a plurality of measurement points P plotted on the relationship line L1 is a point at which the cumulative number of shots ΣFC corresponding to the end of each flushing process in the ink discharge process for the discharge section D[m] and the initial time TF[k] indicated by the phase information NtF[k] acquired in the discharge state determination process for the discharge section D[k] executed at the end of the flushing process are plotted on the graph. In FIG. 9, each of a plurality of measurement points P plotted on the relationship line L2 is a point at which the cumulative number of shots EFC corresponding to the end of each flushing process in the ink discharge process for the discharge section D[j] and the initial time TF[j] indicated by the phase information NtF[j] acquired in the discharge state determination process for the discharge section D[j] executed at the end of the flushing process are plotted on the graph.

As an example, it is assumed in FIG. 8 that the ink discharge process includes the flushing processes for five times and the discharge state determination processes for five times, and it is assumed in FIG. 9 that the ink discharge process includes the flushing processes for three times and the discharge state determination processes for three times.

Hereinafter, the flushing process that is first executed in the ink discharge process is referred to as an “initial discharge operation”.

First, the control section 6 causes the plurality of discharge sections D to execute the initial discharge operation, which is the first flushing process. Specifically, the discharge amount determination section 63 determines the amount of the ink corresponding to the flushing process in which the cumulative number of shots ΣFC is FC0, as the discharge amount. For example, the discharge amount determination section 63 can read the number of shots FC0 set in advance for the initial discharge operation stored in the storage section 5, as the discharge amount. The discharge control section 62 causes the nozzle N to discharge the ink I via the flushing operation for FC0 times. The initial discharge operation is an operation of discharging the ink I that exists at a tip end portion of the nozzle N and has higher viscosity than the ink I existing in the other portions, in order to accurately measure the initial time TF.

Next, the acquisition section 64 acquires the phase information NtF1[m] of each discharge section D[m] at the current point in time from the measurement circuit 9. In the example of the discharge section D[k] illustrated in the graph of FIG. 8, a value of the initial time TF[k] indicated by the phase information NtF1[k] at the point in time when the initial discharge operation is completed is TF0[k] as indicated by a measurement point P0[k]. In the example of the discharge section D[j] illustrated in the graph of FIG. 9, a value of the initial time TF[j] indicated by the phase information NtF1[j] at the point in time when the initial discharge operation is completed is TF0[j] as indicated by a measurement point P0[j]. The value of the initial time TF[j] indicated by the phase information NtF1[j] of the discharge section D[j] is shorter than the value of the initial time TF[k] indicated by the phase information NtF1[k] of the discharge section D[k].

Next, the discharge amount determination section 63 determines the number of shots FC corresponding to the discharge amount of the ink I discharged by the flushing process for one time in the second and subsequent flushing processes. Specifically, the discharge amount determination section 63 reads the number of shots FCp for one flushing process in the second and subsequent flushing processes stored in advance in the storage section 5. The number of shots FCp for one flushing process is set in advance to, for example, the number of shots FC that can discharge an amount of about ¼ of the discharge amount determined on the assumption that all the thickened ink I in the discharge section D exposed to a situation in which moisture in the ink I is evaporated more than usual can be discharged, and is stored in the storage section 5. In addition, in the examples of FIGS. 8 and 9, the number of shots FC that is ¼ of the number of shots obtained by subtracting the number of shots FC0 set in advance for the initial discharge operation from the number of shots corresponding to the discharge amount determined on the assumption that all the thickened ink I in the discharge section D exposed to a situation in which moisture in the ink I is evaporated more than usual can be discharged is set in advance to the number of shots FCp in the flushing process for one time, and is stored in the storage section 5.

Next, the discharge control section 62 executes the flushing operation for FCp times as the second flushing process. In other words, the discharge control section 62 causes each of the plurality of discharge sections D to discharge the amount of the ink I corresponding to the number of shots FCp. As a result, the cumulative number of shots ΣFC is FC1.

Next, the acquisition section 64 acquires the phase information NtF2[m] of each discharge section D[m] at the current point in time from the measurement circuit 9. In the example of the discharge section D[k] illustrated in the graph of FIG. 8, the value of the initial time TF[k] indicated by the phase information NtF2[k] at the point in time when the cumulative number of shots ΣFC is FC1 is TF1[k], as indicated by a measurement point P1[k]. In the example of the discharge section D[j] illustrated in the graph of FIG. 9, the value of the initial time TF[j] indicated by the phase information NtF2[j] at the point in time when the cumulative number of shots ΣFC is FC1 is TF1[j] as indicated by a measurement point P1[j].

Next, the generation section 65 generates difference information DF[m] indicating a difference |TF0[m]−TF1[m]| between an initial time TF0[m] indicated by the phase information NtF1[m] at the point in time when the first flushing process as the initial discharge operation is completed, in other words, at the point in time before the start of the second flushing process, and an initial time TF1[m] indicated by the phase information NtF2[m] at the point in time when the second flushing process is completed, for each of the plurality of discharge sections D.

The discharge control section 62 executes the flushing operation for FCp times as the third flushing process in the discharge section D[m] in which the difference |TF0[m]−TF1[m]| indicated by the difference information DF[m] is equal to or greater than a predetermined value α among the plurality of discharge sections D. In other words, the discharge control section 62 causes each of the discharge sections D[m] in which the difference |TF0[m]−TF1[m]| is equal to or greater than the predetermined value α, to discharge the amount of the ink I corresponding to the number of shots FCp. As a result, the cumulative number of shots ΣFC in the discharge section D[m] in which the difference |TF0[m]−TF1[m]| is equal to or greater than the predetermined value α is FC2.

On the other hand, the discharge control section 62 does not execute the third and subsequent flushing processes for the discharge section D in which the difference |TF0[m]−TF1[m]| indicated by the difference information DF[m] is less than the predetermined value α among the plurality of discharge sections D. This is because, for the discharge section D[m], even when the flushing process is further executed, it is expected that the viscosity of the ink I in the discharge section D[m] is not changed significantly and the flushing process is already sufficiently executed.

Since a difference |TF0[k]−TF1[k]| indicated by difference information DF[k] in the discharge section D[k] illustrated in the graph of FIG. 8 and a difference |TF0[j]−TF1[j]| indicated by difference information DF[j] in the discharge section D[j] illustrated in the graph of FIG. 9 are equal to or greater than the predetermined value α, the amount of the ink I corresponding to the number of shots FCp is discharged from the discharge section D[k] and the discharge section D[j] in the third flushing process.

Next, for the discharge section D for which the third flushing process is executed, the acquisition section 64 acquires the phase information NtF[m] at the current point in time from the measurement circuit 9. In the example illustrated in the graph of FIG. 8, the value of the initial time TF[k] indicated by the phase information NtF[k] at the point in time when the cumulative number of shots ΣFC is FC2 is TF2[k], as indicated by a measurement point P2[k]. In the example illustrated in the graph of FIG. 9, the value of the initial time TF[j] indicated by the phase information NtF[j] at the point in time when the cumulative number of shots ΣFC is FC2 is TF2[j], as indicated by a measurement point P2[j].

Similarly, the generation section 65 generates the difference information DF[m] indicating a difference |TF1[m]−TF2[m]| between the initial time TF1[m] indicated by the phase information NtF1[m] at the point in time when the second flushing process is completed, in other words, at the point in time before the start of the third flushing process, and an initial time TF2[m] indicated by the phase information NtF2[m] at the point in time when the third flushing process is completed, for each of the plurality of discharge sections D[m] for which the third flushing process is executed.

The discharge control section 62 executes the flushing operation for FCp times as the fourth flushing process in the discharge section D[m] in which the difference |TF1[m]−TF2[m]| indicated by the difference information DF[m] is equal to or greater than a predetermined value α among the plurality of discharge sections D for which the third flushing process is executed. As a result, the cumulative number of shots ΣFC in the discharge section D in which the difference |TF1[m]−TF2[m]| is equal to or greater than the predetermined value α is FC3.

On the other hand, the discharge control section 62 does not execute the fourth and subsequent flushing processes in the discharge section D[m] in which the difference |TF1[m]−TF2[m]| indicated by the difference information DF[m] is less than the predetermined value α among the plurality of discharge sections D.

Since a difference |TF1[k]−TF2[k]| indicated by the difference information DF[k] in the discharge section D[k] illustrated in the graph of FIG. 8 is equal to or greater than the predetermined value α, the discharge section D[k] discharges the amount of the ink I corresponding to the number of shots FCp in the fourth flushing process. On the other hand, since the difference |TF0[j]−TF1[j]| indicated by the difference information DF[j] in the discharge section D[j] illustrated in the graph of FIG. 9 is less than the predetermined value α, the fourth and subsequent flushing processes are not executed for the discharge section D[j].

Next, the acquisition section 64 acquires the initial time TF[m] indicated by the phase information NtF[m] at the current point in time from the measurement circuit 9. In the example illustrated in the graph of FIG. 8, the value of the initial time TF[k] indicated by the phase information NtF[k] at the point in time when the cumulative number of shots ΣFC is FC3 is TF3[k], as indicated by a measurement point P3[k].

The generation section 65 generates the difference information DF[m] indicating a difference |TF2[m]−TF3[m]| between the initial time TF2[m] indicated by the phase information NtF1[m] at the point in time when the third flushing process is completed, in other words, at the point in time before the start of the fourth flushing process, and an initial time TF3[m] indicated by the phase information NtF2[m] at the point in time when the fourth flushing process is completed, in each of the plurality of discharge sections D[m] for which the fourth flushing process is executed.

The discharge control section 62 executes the flushing operation for FCp times as the fifth flushing process for the discharge section D[m] in which the difference |TF2[m]−TF3[m]| indicated by the difference information DF[m] is equal to or greater than the predetermined value α among the plurality of discharge sections D for which the fourth flushing process is executed. As a result, the cumulative number of shots ΣFC in the discharge section D[m] in which the difference |TF2[m]−TF3[m]| is equal to or greater than the predetermined value α is FCw.

On the other hand, the discharge control section 62 does not execute the fifth and subsequent flushing processes for the discharge section D[m] in which the difference |TF2[m]−TF3[m]| indicated by the difference information DF is less than the predetermined value α among the plurality of discharge sections D.

Since a difference |TF2[k]−TF3[k]| indicated by the difference information DF[k] for the discharge section D[k] illustrated in the graph of FIG. 8 is equal to or greater than the predetermined value α, the discharge section D[k] discharges the amount of the ink I corresponding to the number of shots FCp in the fifth flushing process.

Next, the acquisition section 64 acquires the initial time TF[m] indicated by the phase information NtF[m] at the current point in time from the measurement circuit 9. In the example illustrated in the graph of FIG. 8, the initial time TF[k] at the point in time when the cumulative number of shots ΣFC is FCw is TFw[k], as indicated by a measurement point Pw[k].

The generation section 65 generates the difference information DF[m] indicating a difference |TF3[m]−TFw[m]| between the initial time TF3[m] indicated by the phase information NtF1[m] at the point in time when the fourth flushing process is completed, in other words, at the point in time before the start of the fifth flushing process, and an initial time TFw[m] indicated by the phase information NtF2[m] at the point in time when the fifth flushing process is completed, in each of the plurality of discharge sections D[m] for which the fifth flushing process is executed.

The discharge control section 62 executes the flushing operation for FCp times as the sixth flushing process for the discharge section D[m] in which the difference |TF3[m]−TFw[m]| indicated by the difference information DF is equal to or greater than the predetermined value α among the plurality of discharge sections D[m] for which the fifth flushing process is executed. As a result, the cumulative number of shots ΣFC in the discharge section D in which the difference |TF3[m]−TFw[m]| is equal to or greater than the predetermined value α is the cumulative number of shots that is FCp times more than a specified cumulative number of shots FCw.

On the other hand, the discharge control section 62 does not execute the sixth and subsequent flushing processes for the discharge section D[m] in which the difference |TF3[m]−TFw[m]| indicated by the difference information DF[m] is less than the predetermined value α among the plurality of discharge sections D.

As the cumulative number of shots FC in the ink discharge process, in the discharge section D[k] illustrated in the graph of FIG. 8, the cumulative number of shots ΣFC until the difference information DF[k] is less than the predetermined value α is FCw, and in the discharge section D[j] illustrated in the graph of FIG. 9, the cumulative number of shots ΣFC until the difference information DF[j] is less than the predetermined value α is FC2.

As described above, in the ink discharge process according to the present embodiment, when the evaporation amount of moisture from the ink I at the start of the ink discharge process is larger in the discharge section D[k] than in the discharge section D[j], the cumulative number of shots in the ink discharge process is larger in the discharge section D[k] than in the discharge section D[j]. In other words, in the ink discharge process according to the present embodiment, when the evaporation amount of moisture from the ink I at the start of the ink discharge process is smaller in the discharge section D[j] than in the discharge section D[k], the cumulative number of shots in the ink discharge process is smaller in the discharge section D[j] than in the discharge section D[k]. That is, in the ink discharge process according to the present embodiment, the thickened ink is discharged from the discharge section D[m] without the excess or insufficiency in accordance with the evaporation amount of moisture from the ink I in the discharge section D[m] at the start of the ink discharge process.

In FIGS. 8 and 9, the value of the acquired TF is monotonically decreased as the cumulative number of shots ΣFC is increased, but this is merely an example. As the cumulative number of shots ΣFC is increased, the value of the acquired initial time TF may be monotonically increased.

In addition, in the examples of FIGS. 8 and 9, the number of shots FCp in the flushing process for one time is set to the number of shots FC that is ¼ of the number of shots obtained by subtracting the number of shots FC0 set in advance for the initial discharge operation from the number of shots corresponding to the discharge amount determined on the assumption that all the thickened ink I in the discharge section D exposed to a situation in which moisture in the ink I is evaporated more than usual can be discharged. However, the number of shots FCp in the flushing process for one time may be set to the number of shots FC that is equal to or greater than ¼ of the number of shots obtained by subtracting the number of shots FC0 set in advance for the initial discharge operation from the number of shots corresponding to the discharge amount determined on the assumption that all the thickened ink I in the discharge section D exposed to a situation in which moisture in the ink I is evaporated more than usual can be discharged, or may be set to the number of shots FC less than ¼ thereof.

In FIGS. 8 and 9, the amount of the ink I discharged from the discharge section D by the flushing operation for FCp times is an example of a “first amount”. Further, in the initial discharge operation, the amount of the ink I discharged from the discharge section D by the flushing operation for FC0 times is less than the first amount.

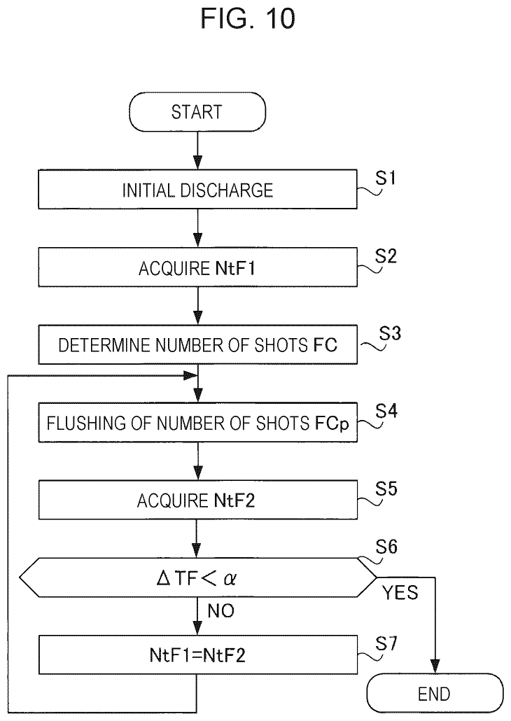

FIG. 10 is a flowchart illustrating the operation of the control section 6.
In step S1, the control section 6 causes the discharge section D to execute the initial discharge operation. Specifically, the discharge amount determination section 63 reads the number of shots FC0 from the storage section 5 as the discharge amount of the initial discharge operation. Further, the discharge control section 62 causes the discharge section D to discharge the ink I via the flushing operation for FC0 times.
In step S2, the acquisition section 64 acquires the phase information NtF1[m] from the measurement circuit 9.
In step S3, the discharge amount determination section 63 reads the number of shots FCp from the storage section 5 as the discharge amount of the flushing process for one time.
In step S4, the discharge control section 62 executes the flushing operation for FCp times.
In step S5, the acquisition section 64 acquires the phase information NtF2 from the measurement circuit 9.
In step S6, the generation section 65 generates the difference information DF indicating a difference ΔTF between the initial time TF indicated by the phase information NtF1 acquired before the flushing process executed in step S4 and the initial time TF indicated by the phase information NtF2 acquired after the flushing process. For the discharge section D in which the difference ΔTF is less than the predetermined value α, that is, the discharge section D for which YES is determined in step S6, the control section 6 terminates the series of processes. For the discharge section D in which the difference ΔTF is equal to or greater than the predetermined value α, that is, the discharge section D for which NO is determined in step S6, the control section 6 rewrites the value of the phase information NtF1 to the current phase information NtF2 in step S7, and returns to step S4 to execute the flushing process.

### 1-6: Effect of the First Embodiment

The maintenance method according to the present embodiment is a maintenance method for the ink jet printer 1 as the liquid discharge apparatus including the plurality of discharge sections D that discharge the ink I as the liquid. The maintenance method includes acquiring the first phase information NtF1 on the viscosity of the ink I filled in each of the plurality of discharge sections D. Further, the maintenance method includes causing each of the plurality of discharge sections D to discharge the first amount of the ink I. Further, in the maintenance method, the second phase information NtF2 on the viscosity of the ink I filled in each of the plurality of discharge sections D is acquired. Further, the maintenance method includes generating the difference information DF indicating the difference between the phase corresponding to the viscosity indicated by the first phase information NtF1 and the phase corresponding to the viscosity indicated by the second phase information NtF2, for each of the plurality of discharge sections D. Further, the maintenance method includes causing the discharge section D in which the difference indicated by the difference information DF is equal to or greater than the predetermined value α among the plurality of discharge sections D, to discharge the first amount of the ink I again. Further, the maintenance method includes causing the discharge section D in which the difference indicated by the difference information DF is less than the predetermined value among the plurality of discharge sections D, not to discharge the ink I.

Therefore, the maintenance method enables the suppression of the excess or insufficiency of the amount of liquid discharged during the ink discharge process. Specifically, in the maintenance method, the flushing process is repeated until the difference in the viscosity of the ink I in the discharge section D before and after the flushing process of discharging the first amount of the ink I is less than the predetermined value α. Therefore, for example, the cumulative number of times of the flushing operation during the ink discharge process in the discharge section D in which the viscosity of the ink I in the discharge section D at the start of the ink discharge process is more thickened than in a normal state is greater than the cumulative number of times of the flushing operation during the ink discharge process in the discharge section D in which the viscosity of the ink I in the discharge section D at the start of the ink discharge process is close to a normal state. As a result, the maintenance method enables the execution of the ink discharge process of discharging an appropriate discharge amount of the ink I in accordance with a situation of the viscosity of the ink I in the discharge section D.

Here, there is also a method of repeating the flushing process until the viscosity of the ink I detected after the flushing process reaches reference viscosity set in advance. However, for example, the viscosity of the ink I supplied to the discharge section D may be changed due to an environmental temperature or the like. Therefore, even when certain reference viscosity and the viscosity of the ink I in the discharge section D after the flushing process are compared, it may not be possible to accurately determine whether or not the ink I in the discharge section D is replaced with the ink I supplied to the discharge section D. On the other hand, in the ink discharge process according to the present embodiment, it is possible to easily and accurately determine whether or not the thickened ink I in the discharge section D is replaced with the supplied ink I by repeating the flushing process until the difference in the viscosity of the ink I in the discharge section D before and after the flushing process of discharging the first amount of the ink I is less than the predetermined value α.

Further, in the maintenance method, each of the plurality of discharge sections D is caused to discharge an amount of the ink I less than the first amount before causing each of the plurality of discharge sections D to discharge the first amount of the ink I.

Therefore, the maintenance method enables the accurate measurement of the initial time TF by discharging the ink I that exists at the tip end portion of the nozzle N and has higher viscosity than the ink I existing in the other portions at the start of the maintenance.

The ink jet printer 1 as the liquid discharge apparatus according to the present embodiment includes the plurality of discharge sections D, the acquisition section 64, the discharge control section 62, and the generation section 65. The plurality of discharge sections D discharge the ink I as the liquid. The acquisition section 64 acquires the phase information NtF on the viscosity of the ink I filled in each of the plurality of discharge sections D. The discharge control section 62 causes each of the plurality of discharge sections D to discharge the ink I. When the acquisition section 64 acquires the first phase information NtF1 corresponding to the viscosity of the ink I filled in each of the plurality of discharge sections D, the discharge control section 62 causes each of the plurality of discharge sections D to discharge the first amount of the ink I, and then the acquisition section 64 acquires the second phase information NtF2 corresponding to the viscosity of the ink I filled in each of the plurality of discharge sections D, the generation section 65 generates the difference information DF indicating the difference between the phase corresponding to the viscosity indicated by the first phase information NtF1 and the phase corresponding to the viscosity indicated by the second phase information NtF2. The discharge control section 62 causes the discharge section D in which the difference indicated by the difference information DF is equal to or greater than the predetermined value α among the plurality of discharge sections D, to discharge the first amount of the ink I again. The discharge control section 62 causes the discharge section D in which the difference indicated by the difference information DF is less than the predetermined value α among the plurality of discharge sections D, not to discharge the ink I.

Therefore, the ink jet printer 1 can suppress the excess or insufficiency of the amount of liquid discharged during the ink discharge process. Specifically, in the ink jet printer 1, the flushing process is repeated until the difference in the viscosity of the ink I in the discharge section D before and after the flushing process of discharging the first amount of the ink I is less than the predetermined value α. Therefore, for example, the cumulative number of times of the flushing operation during the ink discharge process in the discharge section D in which the viscosity of the ink I in the discharge section D at the start of the ink discharge process is more thickened than in a normal state is greater than the cumulative number of times of the flushing operation during the ink discharge process in the discharge section D in which the viscosity of the ink I in the discharge section D at the start of the ink discharge process is close to a normal state. As a result, the ink jet printer 1 can execute the ink discharge process of discharging an appropriate discharge amount of the ink I in accordance with a situation of the viscosity of the ink I in the discharge section D.

In addition, it is possible to more easily and accurately determine whether or not whether or not the thickened ink I in the discharge section D is replaced with the supplied ink I, in the method of repeating the flushing process until the difference in the viscosity of the ink I in the discharge section D before and after the flushing process of discharging the first amount of the ink I is less than the predetermined value α than in the method of repeating the flushing process until the viscosity of the ink I detected after the flushing process reaches the reference viscosity set in advance.

### 2: Second Embodiment

In the present embodiment, the liquid discharge apparatus will be described with an ink jet printer 1A that discharges the ink I to form the image on the recording paper Pp as an example. The ink jet printer 1A is an example of a “liquid discharge apparatus”.

Hereinafter, for the sake of simplification of the description, a difference between the ink jet printer 1A according to the present embodiment and the ink jet printer 1 according to the first embodiment will be mainly described. In addition, the same components among the components included in the ink jet printer 1A as the components included in the ink jet printer 1 may be denoted by the same reference numerals, and the description of the functions thereof may be omitted.

### 2-1: Overview of Ink Jet Printer 1A

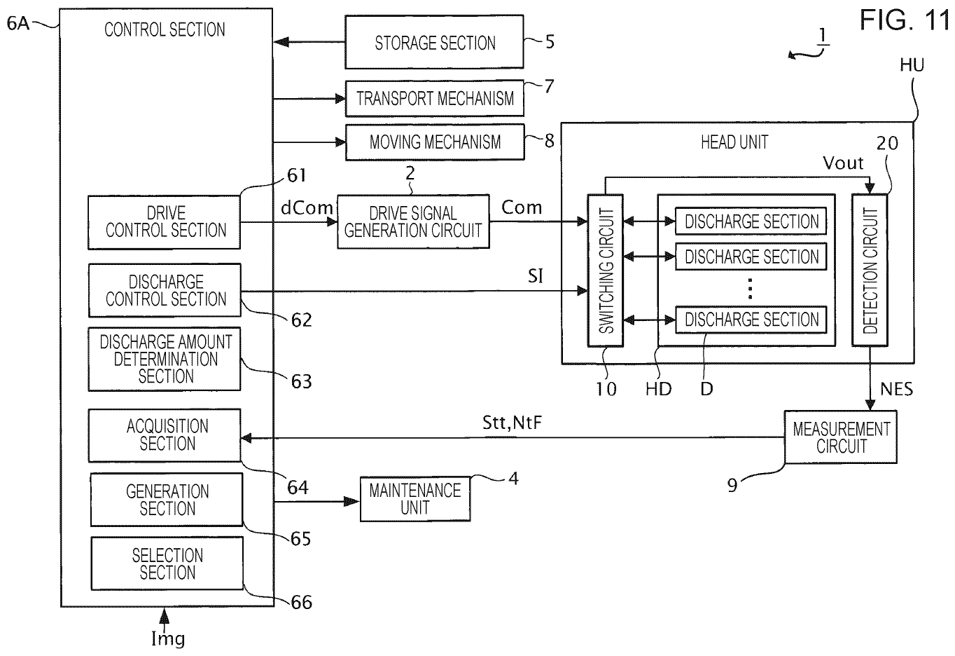

A configuration of the ink jet printer 1A according to the present embodiment will be described with reference to FIG. 11. FIG. 11 is a functional block diagram illustrating an example of the configuration of the ink jet printer 1A according to the present embodiment.

The ink jet printer 1A includes a control section 6A instead of the control section 6 included in the ink jet printer 1.

The control section 6A executes the control program stored in the storage section 5 and operates according to the control program, to function as a selection section 66 in addition to the drive control section 61, the discharge control section 62, the discharge amount determination section 63, the acquisition section 64, and the generation section 65.

The selection section 66 selects a sample discharge section D-S, which is the discharge section D as a sample, from among the discharge sections D.

### 2-2: Ink Discharge Process

Next, the ink discharge process according to the present embodiment will be described.

The ink discharge process according to the present embodiment is different from the ink discharge process according to the first embodiment in that a preparation operation is executed.

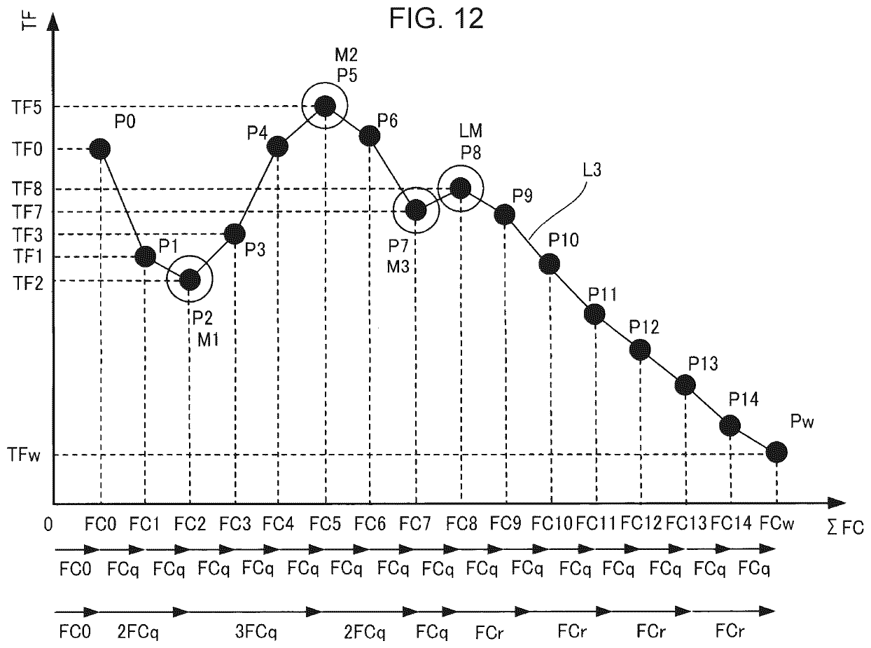

FIG. 12 is an explanatory diagram illustrating the preparation operation for one sample discharge section D-S [m]. FIG. 12 is a graph illustrating a relationship line L3 indicating a relationship between the number of flushing operations (number of shots) in each flushing process for one or a plurality of times included in the preparation operation for the sample discharge section D-S and the initial time TF indicated by phase information NtF, which is the viscosity information acquired in the discharge state determination process executed for the sample discharge section D-S at the start and the end of each flushing process, as in FIGS. 8 and 9.

The number of shots FCq corresponding to the discharge amount of the ink I discharged by the flushing process for one time in the preparation operation for the sample discharge section D-S is set to, for example, the number of shots FC that can discharge an amount corresponding to about 1/15 of the specified cumulative number of shots FCw determined on the assumption that all the thickened ink I in the discharge section D exposed to a situation in which moisture in the ink I is evaporated more than usual can be discharged. In addition, in the example illustrated in FIG. 12, the acquisition section 64 does not always acquire the initial time TF indicated by the phase information NtF in all the flushing processes from the cumulative number of shots ΣFC=FC0 to the cumulative number of shots ΣFC=FCw. In FIG. 12, the relationship line L3 is indicated by a polygonal line, but the relationship line L3 may be a curved line.

In the graphs illustrated in FIGS. 8 and 9, the value of the initial time TF indicated by the acquired phase information NtF monotonically decreased as the cumulative number of shots ΣFC is increased. On the other hand, in the graph illustrated in FIG. 12, as a cumulative value of the number of shots FC is increased, the value of the initial time TF indicated by the acquired phase information NtF is increased or decreased. Such a phenomenon is observed when a distribution of the viscosity of the ink I in the discharge section D is not uniform.

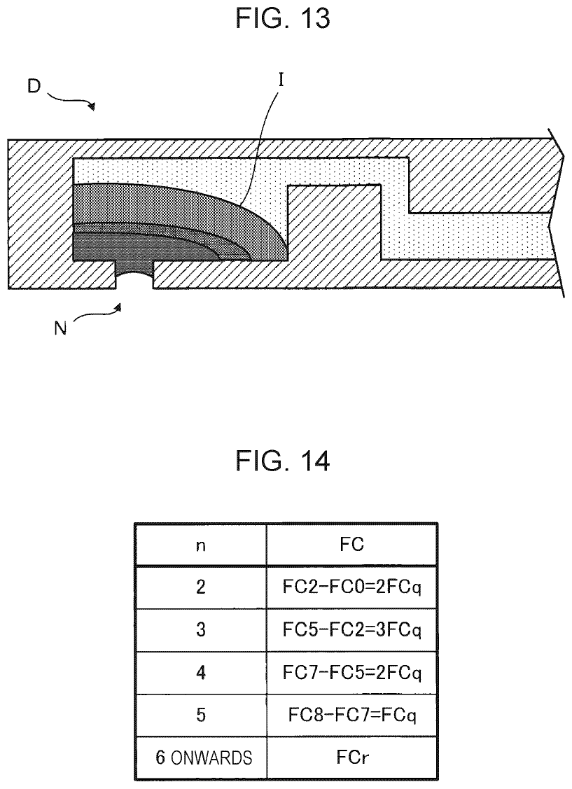

FIG. 13 is a schematic view of the discharge section D illustrated in FIG. 3. FIG. 13 illustrates a state in which the ink I in the discharge section D has different viscosity for each layer. The distribution of the viscosity of the ink I in the discharge section D is not uniform due to the sedimentation of the components of the ink I in the discharge section D caused by the inactivity of the ink jet printer 1A, the absorption of moisture from the surroundings of the nozzle N into the ink I, the evaporation of moisture from the ink I to the surroundings of the nozzle N, and the like. In FIG. 13, the difference in the viscosity is indicated by color shading. When the ink discharge process is executed in a state in which the viscosity of the ink I in the discharge section D is not uniform, the value of the acquired phase information NtF is increased or decreased as the cumulative number of shots ΣFC is increased.

When the flushing process is executed when the viscosity of the ink I in the discharge section D is not uniform, and the flushing process is controlled to be further executed or not executed in accordance with the difference between the phase information NtF1 and the phase information NtF2 which are acquired before and after the flushing process, the discharge of the ink I may be insufficient in the ink discharge process.

Here, as an example, in FIG. 12, it is assumed that TF1, which is the value of the initial time TF indicated by the phase information NtF acquired by the acquisition section 64 at the point in time when the cumulative number of shots ΣFC is FC1, is the phase information NtF1. Next, it is assumed that TF3, which is the value of the initial time TF indicated by the phase information NtF acquired by the acquisition section 64 at the point in time when the cumulative number of shots ΣFC is FC3, is the phase information NtF2. The initial time TF3 is a state in which the thickened ink I remains in the discharge section D. However, for the discharge section D in which a value of a difference |TF1−TF3|, which is a difference between TF1 and TF3, is less than the predetermined value α, the discharge control section 62 does not execute the flushing process even though the ink I in the vicinity of the nozzle N is not refreshed. As a result, problems in the print quality such as unevenness in printing and deviation of landing positions of ink droplets of the ink I occur.

Therefore, the ink jet printer 1A according to the present embodiment executes the preparation operation before executing the ink discharge process of repeatedly executing the flushing process of discharging the amount of the ink I corresponding to the number of shots FCr of a certain number until the difference ΔTF is less than the predetermined value α after the execution of the initial discharge operation and the acquisition of the phase information NtF1 at the point in time when the initial discharge operation is completed, as in the first embodiment. In the preparation operation, first, the selection section 66 selects the sample discharge section D-S from among the plurality of discharge sections D. Next, the discharge of the discharge amount of the ink I corresponding to the number of shots FCq from the sample discharge section D-S via the flushing process and the acquisition of the phase information NtF corresponding to the viscosity of the ink I filled in the sample discharge section D-S via the discharge control section 62 are repeated a plurality of times. As a result, the acquisition section 64 acquires relationship information on a relationship between a cumulative amount of the ink I discharged from the sample discharge section D-S and the viscosity, which is indicated by the relationship line L3 passing through the measurement point P0 to the measurement point Pw in FIG. 12. More specifically, the acquisition section 64 acquires relationship information on a relationship between the cumulative number of shots ΣFC corresponding to the cumulative amount of the ink I discharged from the sample discharge section D-S and the initial time TF corresponding to the viscosity. The discharge amount corresponding to the number of shots FCq is an example of a “third amount”. The third amount is less than the first amount. It is preferable that the third amount is 20% or less of the first amount. As the third amount is decreased, more precise relationship information can be acquired, but a time required to acquire the relationship information is increased.

Next, the discharge amount determination section 63 determines the discharge amount of the ink I to be discharged by remaining discharge sections D-R, other than the sample discharge section D-S, among the plurality of discharge sections D in the preparation operation, based on the relationship information acquired by the acquisition section 64. Specifically, the discharge amount determination section 63 specifies the cumulative number of shots ΣFC corresponding to a measurement point at which the initial time TF is at the maximum or the minimum on the relationship line L3 illustrated in FIG. 12. The measurement point at which the initial time TF is at the maximum or the minimum is referred to as a “change point” hereinafter.

In other words, the relationship information is information indicating a relationship between the cumulative number of shots ΣFC corresponding to the cumulative amount of the ink I discharged from the sample discharge section D-S and the viscosity of the ink I filled in the sample discharge section D-S, in a one-to-one correspondence, at each of a plurality of timings arranged in an order of an increase in the cumulative number of shots ΣFC of the sample discharge section D-S during the preparation operation.

The change point at which the initial time TF is at the maximum is a second timing in three consecutive timings among the plurality of timings when the viscosity corresponding to the second timing is higher than the viscosity corresponding to a first timing and higher than the viscosity corresponding to a third timing. In the graph of FIG. 12, as an example, the initial time TF5 corresponding to the viscosity at the timing of the measurement point P5 is longer than the initial time TF4 corresponding to the viscosity at the timing of the measurement point P4 preceding the timing of the measurement point P5. In addition, the initial time TF5 corresponding to the viscosity at the timing of the measurement point P5 is longer than the initial time TF6 corresponding to the viscosity at the timing of the measurement point P6 following the timing of the measurement point P5. Therefore, the measurement point P5 is a change point at which the initial time TF is at the maximum. Similarly, the measurement point P8 is also a change point at which the initial time TF is at the maximum.

The change point at which the initial time TF is at the minimum is a second timing in three consecutive timings among the plurality of timings when the viscosity corresponding to the second timing is lower than the viscosity corresponding to a first timing and lower than the viscosity corresponding to a third timing. In the graph of FIG. 12, the initial time TF2 corresponding to the viscosity at the timing of the measurement point P2 is shorter than the initial time TF1 corresponding to the viscosity at the timing of the measurement point P1 preceding the timing of the measurement point P2. In addition, the initial time TF2 corresponding to the viscosity at the timing of the measurement point P2 is shorter than the initial time TF3 corresponding to the viscosity at the timing of the measurement point P3 following the timing of the measurement point P2. Therefore, the measurement point P2 is the change point. Similarly, the measurement point P7 is also a change point at which the initial time TF is at the minimum.

As described above, the discharge amount determination section 63 specifies the measurement point P, which is the change point, by comparing the initial times TF corresponding to the viscosity at the consecutive timings based on the relationship information.

In the entire relationship line L3 illustrated in FIG. 12, the measurement point P2, the measurement point P5, the measurement point P7, and the measurement point P8 are the change points. Here, the measurement point P2 is referred to as a “change point M1”. The measurement point P5 is referred to as a “change point M2”. The measurement point P7 is referred to as a “change point M3”. Further, the measurement point P8, which is a last change point, is referred to as a “last change point LM”. Further, when the change point M1, the change point M2, the change point M3, and the last change point LM are arranged in the order of the increase in the cumulative number of shots ΣFC corresponding to each change point, one change point of the two change points consecutively arranged is referred to as a “first change point”, and the other change point is referred to as a “second change point”.

Next, the discharge amount determination section 63 determines the discharge amount for each flushing process of the remaining discharge sections D-R such that the flushing process is terminated at the timings corresponding to the specified change point M1, change point M2, change point M3, and last change point LM.

In the example illustrated in FIG. 12, the discharge amount for each flushing process of the remaining discharge sections D-R is set as illustrated in FIG. 14.

The table in FIG. 14 illustrates the number of shots FC in the n-th flushing process. Here, n is a natural number. More specifically, FIG. 14 illustrates the number of shots FCq in the second to fifth flushing processes in the preparation operation of the remaining discharge sections D-R among the plurality of discharge sections D, and the number of shots FCr of a certain number in the sixth and subsequent flushing processes similar to the flushing process in the first embodiment. The positions or the number of the change points appearing on the relationship line L3 differ depending on the relationship information obtained by the preparation operation of the sample discharge section D-S, and accordingly, the number of times of the flushing process in the preparation operation executed by the remaining discharge sections D-R or the number of shots FCq of each flushing process differs.

In FIG. 14, the description of the initial discharge operation, which is the first flushing process, is omitted. The discharge amount determination section 63 sets the number of shots FC of ΣFCq times corresponding to the cumulative amount of the ink I corresponding to a section from the cumulative number of shots ΣFC=FC0 at the end of the initial discharge operation to the cumulative number of shots ΣFC=FC2 at the change point M1, to the number of shots FCq of the second flushing process of the remaining discharge sections D-R. The discharge amount determination section 63 sets the number of shots FC of 3FCq times corresponding to the cumulative amount of the ink I corresponding to a section from the cumulative number of shots ΣFC=FC2 at the change point M1 to the cumulative number of shots ΣFC=FC5 at the change point M2, to the number of shots FCq of the third flushing process of the remaining discharge sections D-R. The discharge amount determination section 63 sets the number of shots FC of ΣFCq times corresponding to the cumulative amount of the ink I corresponding to a section from the cumulative number of shots ΣFC=FC5 at the change point M2 to the cumulative number of shots ΣFC=FC7 at the change point M3, to the number of shots FCq of the fourth flushing process of the remaining discharge sections D-R. The discharge amount determination section 63 sets the number of shots FC of FCq times corresponding to the cumulative amount of the ink I corresponding to a section from the cumulative number of shots ΣFC=FC7 at the change point M3 to the cumulative number of shots ΣFC=FC8 at the last change point LM, to the number of shots FCq of the fifth flushing process of the remaining discharge sections D-R. Each of the cumulative amounts of the ink I discharged from the remaining discharge sections D-R in each of the second to fifth flushing processes is an example of a “second amount”.

Further, the discharge amount determination section 63 sets the number of shots FCr of a certain number as the number of shots FC of the sixth and subsequent flushing processes after the end of the preparation operation of the remaining discharge sections D-R, as in the first embodiment. Specifically, in the example illustrated in FIG. 12, the discharge amount determination section 63 sets the number of shots FCr of the sixth and subsequent flushing processes to the number of shots FC that is ¼ of the number of shots FC corresponding to the cumulative amount of the ink I corresponding to a section from the cumulative number of shots ΣFC=FC8 to the specified cumulative number of shots FCw. However, the discharge amount determination section 63 may set the number of shots FCr of the sixth and subsequent flushing processes to the number of shots FC corresponding to a value obtained by dividing the number of shots FC corresponding to the cumulative amount of the ink I corresponding to a section from the cumulative number of shots ΣFC=FC8 to the specified cumulative number of shots FCw into three or less, a value obtained by dividing the number of shots FC corresponding to the cumulative amount of the ink I corresponding to a section from the cumulative number of shots ΣFC=FC8 to the specified cumulative number of shots FCw into five or more, or a value set in advance to any value. In the example illustrated in FIG. 12, the discharge amount of the ink I discharged for each of the sixth and subsequent flushing processes is an example of a “first amount”.

When the change point at which the viscosity is changed to the maximum or the minimum does not exist on the relationship line representing the relationship between the cumulative amount indicated by the relationship information and the viscosity, the discharge amount determination section 63 sets the number of shots FC in the flushing process for one time of the remaining discharge sections D-R during the preparation operation to the number of shots FC that is the same as the number of shots FCr in the flushing process for one time after the preparation operation.

However, when the change point does not exist on the relationship line indicated by the relationship information, the number of shots FC in the flushing process for one time of the remaining discharge sections D-R may be determined based on the specified cumulative number of shots FCw, as in the first embodiment. For example, when the change point does not exist on the relationship line indicated by the relationship information, the number of shots FC, which is ¼ of the specified cumulative number of shots FCw, may be used as the number of shots FC in the flushing process for one time of the remaining discharge sections D-R. In this case, the number of shots FC, which is ¼ of the specified cumulative number of shots FCw, is an example of a “first amount”. In addition, for example, when the change point does not exist on the relationship line indicated by the relationship information, the number of shots FC, which is ¼ of the number of shots obtained by subtracting the number of shots FC0 from the specified cumulative number of shots FCw, may be used as the number of shots FC in the flushing process for one time of the remaining discharge sections D-R. In this case, the number of shots FC, which is ¼ of the number of shots obtained by subtracting the number of shots FC0 from the specified cumulative number of shots FCw, is an example of a “first amount”.

Next, the discharge control section 62 executes the flushing operation for 2FCq times as the second flushing process for the remaining discharge sections D-R.

Next, the acquisition section 64 acquires the phase information NtF2[m] of the remaining discharge sections D-R[m] at the current point in time from the measurement circuit 9.

Next, the generation section 65 generates the difference information DF[m] indicating a difference |TF0[m]−TF2[m]| between the initial time TF0[m] indicated by the phase information NtF1[m] at the point in time when the first flushing process as the initial discharge operation is completed, in other words, at the point in time before the start of the second flushing process, and the initial time TF2[m] indicated by the phase information NtF2[m] at the point in time when the second flushing process is completed.

The discharge control section 62 executes, among the remaining discharge sections D-R, the flushing operation for 3FCq times as the third flushing process for the remaining discharge section D-R in which the difference |TF0[m]−TF2[m]| indicated by the difference information DF[m] is equal to or greater than the predetermined value α, while not executing the third and subsequent flushing processes for the remaining discharge section D-R in which the difference |TF0[m]−TF2[m]| indicated by the difference information DF[m] is less than the predetermined value α.

Next, the acquisition section 64 acquires the phase information NtF[m] at the current point in time from the measurement circuit 9 for the remaining discharge sections D-R for which the third flushing process is executed.

Similarly, the difference information DF[m] indicating the difference between the initial time TF indicated by the phase information NtF1[m] and the initial time TF indicated by the phase information NtF2[m] which are acquired before and after the n-th flushing process is generated, and the n+1th flushing process is executed for the discharge section D[m] in which the difference indicated by the difference information DF[m] is equal to or greater than the predetermined value α, but the n+1th and subsequent flushing processes are not executed for the discharge section D[m] in which the difference is less than the predetermined value α.

In the present embodiment, in the preparation operation in which “n≤5”, among the remaining discharge sections D-R, for the discharge section D[m] in which the difference between the initial time TF indicated by the phase information NtF1[m] and the initial time TF indicated by the phase information NtF2[m] which are acquired before and after the n-th flushing process is less than the predetermined value α, the n+1th and subsequent flushing processes are not executed, but the present disclosure is not limited to such an aspect.

For example, in the preparation operation in which “n≤5”, among the remaining discharge sections D-R, for the discharge section D[m] in which the difference between the initial time TF indicated by the phase information NtF1[m] and the initial time TF indicated by the phase information NtF2[m] which are acquired before and after the n-th flushing process is less than the predetermined value α, the n+1th and subsequent flushing processes may be executed. In addition, for example, in the preparation operation in which “n≤5”, the phase information NtF[m] need not be acquired for the remaining discharge sections D-R before and after the n-th flushing process. That is, in the ink discharge process, the sixth and subsequent flushing processes may be executed for the remaining discharge sections D-R on the assumption that the preparation operation for the remaining discharge sections D-R is completed. Even in this case, when n≥6, among the remaining discharge sections D-R, for the discharge section D[m] in which the difference between the initial time TF indicated by the phase information NtF1[m] and the initial time TF indicated by the phase information NtF2[m] which are acquired before and after the n-th flushing process is less than the predetermined value α, the n+1th and subsequent flushing processes are not executed.

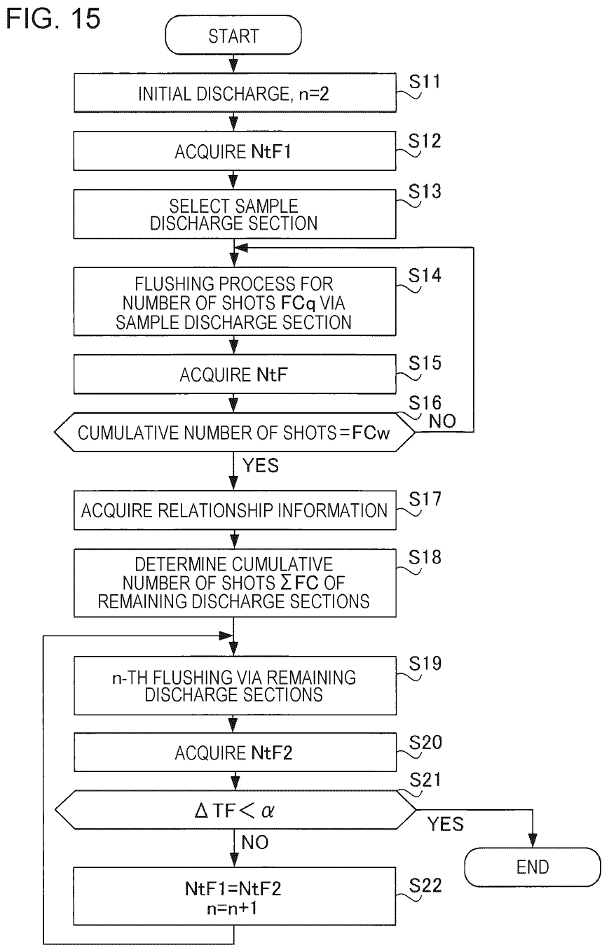

FIG. 15 is a flowchart illustrating an operation of the control section 6A.
In step S11, the control section 6A causes the discharge section D to execute the initial discharge operation, which is the first flushing process, and sets the variable n to 2. Specifically, the discharge amount determination section 63 reads the number of shots FC0 from the storage section 5 as the discharge amount of the initial discharge operation. Further, the discharge control section 62 causes the discharge section D to discharge the ink I via the flushing operation for FC0 times.
In step S12, the acquisition section 64 acquires the initial time TF[m] for the discharge section D[m] as the phase information NtF1[m] from the measurement circuit 9, and stores the current cumulative number of shots ΣFC [m] and the acquired initial time TF[m] in the storage section 5.
In step S13, the selection section 66 selects the sample discharge section D-S from among the plurality of discharge sections D.
In step S14, the discharge amount determination section 63 reads the number of shots FCq from the storage section 5 as the discharge amount of the sample discharge section D-S, and the discharge control section 62 executes the flushing process including the flushing operation for FCq times for the sample discharge section D-S. Here, the amount of the ink I discharged by the number of shots FC=FCq is an example of a “third amount”.
In step S15, after the flushing process in step S14, the acquisition section 64 acquires the phase information NtF indicating the initial time TF for the sample discharge section D-S from the measurement circuit 9, and stores the current cumulative number of shots ΣFC of the sample discharge section D-S and the acquired initial time TF in the storage section 5.
In step S16, it is determined whether or not the cumulative number of shots ΣFC of the sample discharge section D-S reaches the specified cumulative number of shots FCw. When the cumulative number of shots ΣFC of the sample discharge section D-S is the specified cumulative number of shots FCw, that is, when YES is determined in step S16, the control section 6A executes the process in step S17. When the cumulative number of shots ΣFC of the sample discharge section D-S is less than the specified cumulative number of shots FCw in step S16, that is, when NO is determined in step S16, the control section 6A executes the process in step S14.
In step S17, the control section 6A acquires the relationship information on the relationship between the cumulative amount of the ink I discharged from the sample discharge section D-S and the viscosity, based on the cumulative number of shots ΣFC related to the sample discharge section D-S and the initial time TF corresponding to the cumulative number of shots ΣFC which are stored in the storage section 5.
In step S18, the discharge amount determination section 63 determines the number of shots FCq corresponding to the discharge amount of the ink I to be discharged in the flushing process during the preparation operation by the remaining discharge sections D-R, other than the sample discharge section D-S, among the plurality of discharge sections D based on the relationship information acquired in step S17, and stores the number of shots FCq in the storage section 5. In the present embodiment, as described with reference to FIG. 14, the discharge amount determination section 63 determines the number of shots FCq and the number of shots FCr in each of the second and subsequent flushing processes for the remaining discharge sections D-R.
In step S19, the control section 6A executes the flushing process corresponding to the n-th flushing process stored in the storage section 5 for the remaining discharge sections D-R.
In step S20, the acquisition section 64 acquires the phase information NtF2[m] of the remaining discharge section D-R[m] from the measurement circuit 9.
In step S21, the generation section 65 generates the difference information DF indicating the difference ΔTF between the initial time TF[m] indicated by the phase information NtF1[m] acquired before the n-th flushing process and the initial time TF[m] indicated by the phase information NtF2[m] acquired after the n-th flushing process, for the remaining discharge section D-R[m]. Then, it is determined whether or not the difference ΔTF indicated by the difference information DF is less than the predetermined value α. For the remaining discharge section D-R[m] in which the difference ΔTF is less than the predetermined value α, that is, the remaining discharge section D-R[m] for which YES is determined in step S21, the control section 6A terminates the series of processes. For the remaining discharge section D-R[m] in which the difference ΔTF is equal to or greater than the predetermined value α, that is, the remaining discharge section D-R[m] for which NO is determined in step S21, the control section 6A rewrites the value of the phase information NtF1[m] to the current phase information NtF2[m] and increases the value of the variable n by one from the current value in step S22, and returns to step S19.

### 2-3: Effect of Second Embodiment

In the maintenance method according to the present embodiment, the preparation operation is executed before causing each of the plurality of discharge sections D to discharge the ink I as the first amount of the liquid. The preparation operation includes selecting the sample discharge section D-S from among the plurality of discharge sections D. In addition, the preparation operation includes repeating, a plurality of times, the acquisition of the phase information NtF on the viscosity of the ink I filled in the sample discharge section D-S and the discharge of the ink I from the sample discharge section D-S, to acquire the relationship information on the relationship between the cumulative amount of the ink I discharged from the sample discharge section D-S during the preparation operation and the viscosity. In addition, the preparation operation includes determining the second amount that is the amount of the ink I to be discharged by the remaining discharge sections D-R in the preparation operation based on the relationship information. In addition, the preparation operation includes causing the remaining discharge sections D-R among the plurality of discharge sections D, to discharge the second amount of the ink I.

As a result, the maintenance method enables the discharge of an appropriate discharge amount of the ink I in accordance with a situation of the viscosity of the ink I in the discharge section D even when the distribution of the viscosity of the ink I in the discharge section D is not uniform.

Further, in the maintenance method, the second amount is the amount of the difference in the cumulative amount at each of the first change point and the second change point that are consecutive among change points at which the viscosity is at the maximum or the minimum on the relationship line representing the relationship between the cumulative amount and the viscosity indicated by the relationship information.

As a result, the maintenance method enables the discharge of an appropriate discharge amount of the ink I in accordance with a situation of the viscosity of the ink I in the discharge section D even when the distribution of the viscosity of the ink I in the discharge section D is not uniform.

Further, in the maintenance method, the preparation operation includes repeating the acquisition of the phase information NtF from the sample discharge section D-S and the discharge of the ink I as a third amount of the liquid when the relationship information is acquired. Further, in the maintenance method, the third amount is less than the first amount.

Therefore, the maintenance method enables the generation of detailed relationship information. Further, the maintenance method enables the discharge of a more appropriate discharge amount of the ink I depending on the situation of the viscosity of the ink I in the discharge section D based on the relationship information.

Further, in the maintenance method, when the relationship line representing the relationship between the cumulative amount and the viscosity indicated by the relationship information has no change point at which the viscosity is at the maximum or the minimum, the second amount is set to the first amount.

Therefore, the maintenance method enables the simplification of the preparation operation when there is no change point at which the viscosity is at the maximum or the minimum on the relationship line.

Further, in the maintenance method, each of the plurality of discharge sections D is caused to discharge an amount of the ink I less than the first amount before the preparation operation.

Therefore, the maintenance method enables the accurate measurement of the initial time TF by discharging the ink I that exists at the tip end portion of the nozzle N and has higher viscosity than the ink I existing in the other portions.

### 3: Third Embodiment

In the present embodiment, the liquid discharge apparatus will be described with an ink jet printer 1B that discharges the ink I to form the image on the recording paper Pp as an example. The ink jet printer 1B is an example of a “liquid discharge apparatus”.

Hereinafter, for the sake of simplification of the description, a difference between the ink jet printer 1B according to the present embodiment and the ink jet printer 1A according to the second embodiment will be mainly described. In addition, the same components included in the ink jet printer 1B as the components included in the ink jet printer 1 may be denoted by the same reference numerals, and the description of the functions thereof may be omitted.

### 3-1: Overview of Ink Jet Printer 1B

Since the configuration of the ink jet printer 1B according to the present embodiment is basically the same as the configuration of the ink jet printer 1A according to the second embodiment, the same functional block diagram as FIG. 11 and the description thereof are omitted.

### 3-2: Ink Discharge Process

Next, the ink discharge process according to the present embodiment will be described.

In the ink discharge process according to the second embodiment, the discharge amount of the ink I discharged in the flushing process executed by the remaining discharge sections D-R other than the sample discharge section D-S is determined based on all the change points at which the initial time TF is at the maximum or the minimum on the relationship line representing the relationship between the cumulative number of shots ΣFC corresponding to the cumulative amount of the ink I and the initial time TF corresponding to the viscosity, the relationship being indicated by the relationship information on the relationship between the cumulative amount of the ink I discharged from the sample discharge section D-S and the viscosity.

On the other hand, in the ink discharge process according to the present embodiment, the discharge amount determination section 63 determines the discharge amount of the ink I discharged in the flushing process executed by the remaining discharge sections D-R other than the sample discharge section D-S based on the last change point LM among all the change points at which the initial time TF is at the maximum or the minimum on the relationship line representing the relationship between the number of shots FC corresponding to the cumulative amount of the ink I and the initial time TF corresponding to the viscosity, the relationship being indicated by the relationship information.

The discharge amount determination section 63 determines the discharge amount of the ink I to be discharged by remaining discharge sections D-R, other than the sample discharge section D-S, among the plurality of discharge sections D in the preparation operation, based on the relationship information acquired by the acquisition section 64. Specifically, the discharge amount determination section 63 specifies the cumulative number of shots ΣFC corresponding to the change point at which the initial time TF is at the maximum or the minimum on the relationship line L3 illustrated in FIG. 12, as in the second embodiment. The discharge amount determination section 63 specifies the cumulative number of shots ΣFC=FC8 corresponding to the last change point LM, which has the maximum number of times in the cumulative number of shots ΣFC corresponding to the specified change point.

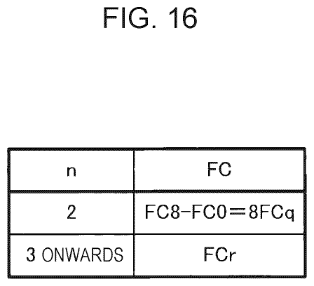

FIG. 16 is a table illustrating the number of shots FC in the n-th flushing process for the discharge section D other than the sample discharge section D-S in the example illustrated in FIG. 12, in the third embodiment. In the graph illustrated in FIG. 12, the discharge amount determination section 63 determines the number of shots FC=8FCq from the cumulative number of shots ΣFC=FC0 corresponding to the measurement point P0 at the end of the initial discharge operation to the cumulative number of shots ΣFC=FC8 corresponding to the last change point LM as the number of shots FCq in the second flushing process of the remaining discharge sections D-R. Thereafter, the discharge control section 62 sets the number of shots FCr of the flushing process after the end of the preparation operation of the remaining discharge sections D-R to the number of shots FC corresponding to a value obtained by dividing the number of shots FC from the cumulative number of shots ΣFC=FC8 to the specified cumulative number of shots FCw into any number, or a value set in advance to any value, as in the second embodiment. The discharge amount of the ink I discharged for each flushing process executed after the end of the preparation operation is an example of a “first amount”.

The amount of the ink I discharged from the remaining discharge sections D-R by the second flushing operation of the flushing processes executed by the remaining discharge sections D-R in the preparation operation is an example of a “second amount”, and the discharge amount of the ink I discharged from the remaining discharge sections D-R in each flushing process executed after the end of the preparation operation is an example of a “first amount”.

Thereafter, the discharge control section 62 executes the flushing operation for 8FCq times as the second flushing process for the remaining discharge sections D-R.

Next, the acquisition section 64 acquires the phase information NtF2[m] of the remaining discharge sections D-R[m] at the current point in time from the measurement circuit 9.

Next, the generation section 65 generates the difference information DF[m] indicating a difference |TF0[m]−TF8[m]| between the initial time TF0[m] indicated by the phase information NtF1[m] at the point in time when the first flushing process as the initial discharge operation is completed, in other words, at the point in time before the start of the second flushing process, and the initial time TF8[m] indicated by the phase information NtF2[m] at the point in time when the second flushing process is completed.

The discharge control section 62 executes, among the remaining discharge sections D-R, the flushing operation for FCr times as the third flushing process for the remaining discharge section D-R in which the difference |TF0[m]−TF8[m]| indicated by the difference information DF is equal to or greater than the predetermined value α, while not executing the third and subsequent flushing processes for the remaining discharge section D-R in which the difference |TF0[m]−TF8[m]| indicated by the difference information DF is less than the predetermined value α.

Next, the acquisition section 64 acquires the phase information NtF[m] at the current point in time from the measurement circuit 9 for the remaining discharge sections D-R for which the third flushing process is executed.

Similarly, the difference information DF[m] indicating the difference between the initial time TF indicated by the phase information NtF1[m] and the initial time TF indicated by the phase information NtF2[m] which are acquired before and after the n-th flushing process is generated, and the n+1th flushing process is executed for the discharge section D[m] in which the difference ΔTF indicated by the difference information DF[m] is equal to or greater than the predetermined value α, but the n+1th and subsequent flushing processes are not executed for the discharge section D[m] in which the difference ΔTF indicated by the difference information DF[m] is less than the predetermined value α.

In the present embodiment, in the ink discharge process, among the remaining discharge sections D-R, for the discharge section D[m] in which the difference between the initial time TF0[m] indicated by the phase information NtF1[m] and the initial time TF8[m] indicated by the phase information NtF2[m] which are acquired before and after the second flushing process is less than the predetermined value α, the third and subsequent flushing processes are not executed, but the present disclosure is not limited to such an aspect.

For example, in the ink discharge process, among the remaining discharge sections D-R, for the discharge section D[m] in which the difference between the initial time TF0[m] indicated by the phase information NtF1[m] and the initial time TF8[m] indicated by the phase information NtF2[m] which are acquired before and after the second flushing process is less than the predetermined value «, the third and subsequent flushing processes may be executed. In addition, for example, in the ink discharge process, the phase information NtF[m] need not be acquired for the remaining discharge sections D-R before and after the second flushing process. That is, in the present embodiment, in the ink discharge process, the third and subsequent flushing processes may be executed for the remaining discharge sections D-R on the assumption that the preparation operation for the remaining discharge sections D-R is completed. Even in this case, when n≥3, among the remaining discharge sections D-R, for the discharge section D[m] in which the difference between the initial time TF indicated by the phase information NtF1[m] and the initial time TF indicated by the phase information NtF2[m] which are acquired before and after the n-th flushing process is less than the predetermined value α, the n+1th and subsequent flushing processes are not executed.

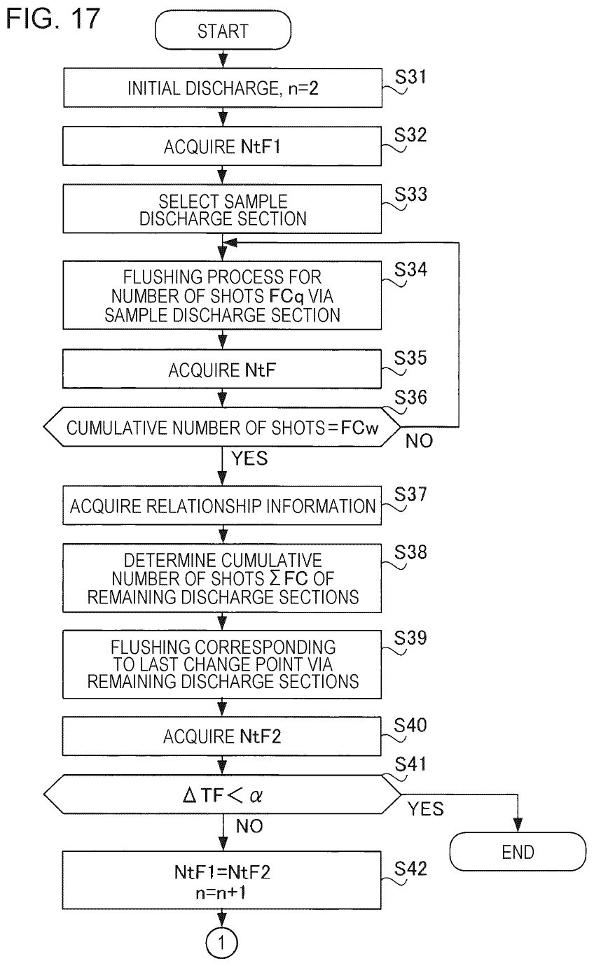

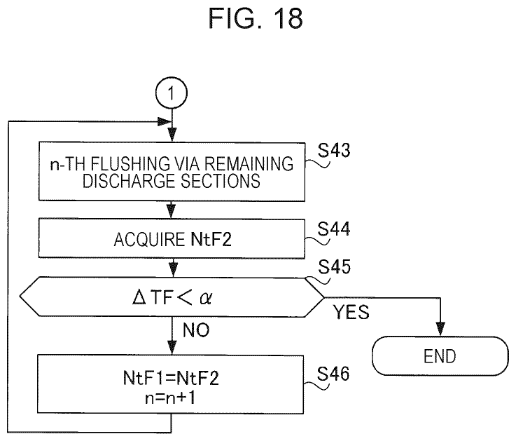

FIGS. 17 and 18 are flowcharts illustrating the operation of the control section 6A. Since steps S31 to S38 in the flowcharts illustrated in FIGS. 17 and 18 are the same as steps S11 to S18 in the flowchart illustrated in FIG. 15, the description thereof is omitted. Further, since steps S43 to S46 in the flowcharts illustrated in FIGS. 17 and 18 are the same as steps S19 to S22 in the flowchart illustrated in FIG. 15, the description thereof is omitted.

In step S39, the control section 6A executes the second flushing process corresponding to the last change point LM stored in the storage section 5 for the remaining discharge sections D-R.

In step S40, the control section 6A acquires the phase information NtF2[m] of the remaining discharge section D-R[m] from the measurement circuit 9.

In step S41, the control section 6A generates the difference information DF indicating the difference ΔTF between the initial time TF0[m] indicated by the phase information NtF1[m] acquired before the second flushing process and the initial time TF8[m] indicated by the phase information NtF2[m] acquired after the second flushing process, for the remaining discharge section D-R[m]. Then, it is determined whether or not the difference ΔTF indicated by the difference information DF is less than the predetermined value α. For the remaining discharge section D-R[m] in which the difference ΔTF is less than the predetermined value α, that is, the remaining discharge section D-R[m] for which YES is determined in step S41, the control section 6A terminates the series of processes. For the remaining discharge section D-R[m] in which the difference ΔTF is equal to or greater than the predetermined value α, that is, the remaining discharge section D-R[m] for which NO is determined in step S41, the control section 6A rewrites the value of the phase information NtF1[m] to the current phase information NtF2[m] and increases the value of the variable n by one from the current value in step S42, and returns to step S43.

### 3-3: Effect of Third Embodiment

In the maintenance method according to the present embodiment, the second amount is set to the maximum cumulative amount among the cumulative amounts corresponding to the change points at which the viscosity is at the maximum or the minimum on the relationship line representing the relationship between the cumulative amount and the viscosity indicated by the relationship information.

Therefore, the maintenance method enables the simplification of the preparation operation.

### 4: Modification Example

Each of the above-described embodiment can be variously modified. A specific modification aspect will be described below. The aspects illustrated below and the aspects illustrated in the above-described embodiment can be appropriately combined within the range in which the aspects are not inconsistent with each other. In addition, in the modification examples described below, elements having the same effects or functions as those of the embodiment are denoted by the reference numerals used in the above description, and each detailed description thereof is appropriately omitted.

### 4-1: Modification Example 1

In the above-described embodiment, the acquisition section 64 acquires the initial time TF as the phase information NtF to be acquired from the measurement circuit 9. However, the acquisition section 64 may acquire a cycle of the residual vibration signal NES[m] instead of the initial time TF as the phase information NtF.

### 4-2: Modification Example 2

In the ink discharge process according to the second embodiment and the third embodiment, the sample discharge section D-S discharges the ink I via the flushing process of acquiring the relationship information, and does not discharge the ink I when the flushing process is executed for the remaining discharge sections D-R, but the present disclosure is not limited thereto. For example, the control section 6A may also discharge the ink I from the sample discharge section D-S together with the remaining discharge sections D-R in the flushing process in which the discharge amount is determined based on the relationship information. In this case, in the sample discharge section D-S, the flushing process may be repeated until the difference information DF between the phase information NtF1 and the phase information NtF2 which are acquired before and after the flushing process is less than the predetermined value α.

### 4-3: Modification Example 3

In the flushing process according to the above-described embodiment, the initial discharge operation is executed, but the initial discharge operation may be omitted when the initial time TF can be accurately measured.

### 4-4: Modification Example 4

In the flushing process according to the second embodiment, the discharge amount for each flushing process of the remaining discharge sections D-R is determined such that the flushing process is terminated at the timing corresponding to all the change points at which the initial time TF is at the maximum or the minimum on the relationship line L3, but the present disclosure is not limited to this. For example, the control section 6A may determine the discharge amount for each flushing process such that the flushing process is terminated at the timing corresponding to one or more change points selected from the change points at which the initial time TF is at the maximum or the minimum on the relationship line L3.

### 4-5: Modification Example 5

In the flushing process according to the third embodiment, the number of shots FC=8FCq from the cumulative number of shots ΣFC=FC0 corresponding to the measurement point P0 at the end of the initial discharge operation to the cumulative number of shots ΣFC=FC8 corresponding to the last change point LM is determined as the number of shots FCq in the second flushing process of the remaining discharge sections D-R, but the present disclosure is not limited to this. For example, the number of shots FC=FC0+8FCq of the cumulative number of shots ΣFC=FC8 corresponding to the last change point LM may be determined as the number of shots FCq in the second flushing process of the remaining discharge sections D-R.

What is claimed is:

1. A maintenance method of a liquid discharge apparatus including a plurality of discharge sections that is configured to discharge liquid, the maintenance method comprising:
acquiring a first viscosity information on viscosity of the liquid filled in each of the plurality of discharge sections;
causing each of the plurality of discharge sections to discharge a first amount of the liquid;
acquiring a second viscosity information on viscosity of the liquid filled in each of the plurality of discharge sections;
generating a difference information indicating a difference between the viscosity indicated by the first viscosity information and the viscosity indicated by the second viscosity information in each of the plurality of discharge sections;
causing a discharge section in which the difference indicated by the difference information is equal to or greater than a predetermined value among the plurality of discharge sections, to discharge the first amount of the liquid again; and
causing a discharge section in which the difference indicated by the difference information is less than the predetermined value among the plurality of discharge sections, not to discharge the liquid.

2. The maintenance method according to claim 1, wherein
a preparation operation is executed before causing each of the plurality of discharge sections to discharge the first amount of the liquid, and
the preparation operation includes
selecting a sample discharge section from among the plurality of discharge sections,
repeating, a plurality of times, acquisition of a viscosity information on viscosity of the liquid filled in the sample discharge section and discharge of the liquid from the sample discharge section, to acquire relationship information on a relationship between a cumulative amount of the liquid discharged from the sample discharge section during the preparation operation and the viscosity,
determining a second amount that is a discharge amount of the liquid to be discharged by the discharge section in the preparation operation based on the relationship information, and
causing a discharge section, other than the sample discharge section, among the plurality of discharge sections, to discharge the second amount of the liquid.

3. The maintenance method according to claim 1, wherein
each of the plurality of discharge sections is caused to discharge an amount of the liquid less than the first amount before causing each of the plurality of discharge sections to discharge the first amount of the liquid.

4. The maintenance method according to claim 2, wherein
the second amount is an amount of a difference in the cumulative amount at each of a first change point and a second change point that are consecutive among change points at which the viscosity is at a maximum or a minimum on a relationship line representing the relationship between the cumulative amount and the viscosity indicated by the relationship information.

5. The maintenance method according to claim 2, wherein
the second amount is set based on a maximum cumulative amount among cumulative amounts corresponding to change points at which the viscosity is at a maximum or a minimum on a relationship line representing the relationship between the cumulative amount and the viscosity indicated by the relationship information.

6. The maintenance method according to claim 2, wherein
the preparation operation includes repeating acquisition of the viscosity information from the sample discharge section and discharge of a third amount of the liquid when the relationship information is acquired, and
the third amount is less than the first amount.

7. The maintenance method according to claim 2, wherein
when a relationship line representing the relationship between the cumulative amount and the viscosity indicated by the relationship information has no change point at which the viscosity is at a maximum or a minimum, the second amount is set to the first amount.

8. The maintenance method according to claim 2, wherein
each of the plurality of discharge sections is caused to discharge an amount of the liquid less than the first amount before the preparation operation.

9. A liquid discharge apparatus comprising:
a plurality of discharge sections that is configured to discharge liquid;
an acquisition section that is configured to acquire a viscosity information on viscosity of the liquid filled in each of the plurality of discharge sections;
a discharge control section that is configured to cause each of the plurality of discharge sections to discharge the liquid; and
a generation section that, when the acquisition section acquires a first viscosity information on viscosity of the liquid filled in each of the plurality of discharge sections, the discharge control section causes each of the plurality of discharge sections to discharge a first amount of the liquid, and then the acquisition section acquires a second viscosity information on viscosity of the liquid filled in each of the plurality of discharge sections, is configured to generate a difference information indicating a difference between the viscosity indicated by the first viscosity information and the viscosity indicated by the second viscosity information, wherein
the discharge control section
causes a discharge section in which the difference indicated by the difference information is equal to or greater than a predetermined value among the plurality of discharge sections, to discharge the first amount of the liquid again, and
causes a discharge section in which the difference indicated by the difference information is less than the predetermined value among the plurality of discharge sections, not to discharge the liquid.
